(19) United States
(12) Patent Application Publication
(10) Pub. No.: US 2019/0392460 A1
(43) Pub. Date: Dec. 26, 2019

(54) GRAPHICAL METHOD FOR AGGREGATE ECONOMIC ANALYSIS

(71) Applicant: Erdan WANG, (US)

(72) Inventors: Erdan WANG, Dalian (CN); Weiwei WANG, Dalian (CN)

(21) Appl. No.: 16/439,329

(22) Filed: Jun. 12, 2019

Related U.S. Application Data
(63) Continuation of application No. PCT/CN2017/113522, filed on Nov. 29, 2017.

(30) Foreign Application Priority Data
Dec. 12, 2016 (CN) 201611140286.9

(51) Int. Cl. G06Q 30/02; G06Q 10/04

(52) U.S. Cl. CPC G06Q 30/0202; G06Q 10/04

(57) ABSTRACT

Disclosed is a graphical method for aggregate economic analysis, including: based on basic measurement units and aggregate models selected by Keynes, constructing a NS-ND model and an AS-AD model measured in the real wage-unit; obtaining a 4D model (N^{w}-Y-Wⁱ/P model) of supply and demand by combining the coordinates of the two models to establish unified 3D coordinates, where a bottom plane of the model being a N^{w}-Y^{d} model of supply-demand equilibrium; and analyzing different changes in a supply-demand equilibrium curve of the N^{w}-Y^{d} model relative to a full employment curve to complete the aggregate economic analysis of the economy. The graphical method can not only scientifically analyze long-term economic development trends and changes in economic cycles of various countries, but also can more accurately analyze the direction and magnitude of the changes in the economy in the short term.

### CROSS-REFERENCE TO RELATED APPLICATIONS

This application is a continuation of International Application No. PCT/CN2017/113522 with a filling date of Nov. 29, 2017, designating the United states, now pending, and further claims to the benefit of priority from Chinese Application No. 201611140286.9 with a filing date of Dec. 12, 2016. The content of the aforementioned applications, including any intervening amendments thereto, are incorporated herein by reference.

### FIELD OF THE INVENTION

The present invention relates to a graphical method for aggregate economic analysis, involving patent classification number G06 computing; calculating; counting G06Q data processing systems or methods specially adapted for administrative, commercial, financial, managerial, supervisory or forecasting purposes; G06Q10/00 administration of processing systems or methods specially adapted for administrative, commercial, financial, managerial, supervisory or forecasting purposes, not included in other classes; and management G06Q10/04 forecasting or optimization, e.g., linear planning, “traveling salesman problems” or “cutting stock problems”.

### BACKGROUND ART

For macroeconomics, the most basic concept should be the expression of aggregate supply and aggregate demand. Macroeconomics builds an analytical framework of aggregate supply and aggregate demand based on an aggregate supply function and an aggregate demand function. Macroeconomics defines aggregate supply Y=F(P) as a function of price level, and defines aggregate demand Y=ƒ(P) as a function of price level.

However, when Keynes created the two concepts, the defined aggregate supply as a function of employment Z=Φ(N), and defined aggregate demand as a function of employment D=ƒ(N), which means that the labor supply-demand model and the product aggregate supply-demand model are inseparable, and are an indivisible whole in the analysis system of supply-demand equilibrium. Therefore, the mainstream macroeconomic model “ignores” the key variable that is employment associated with the aggregate supply function and the aggregate demand function, which may become a fatal flaw in the macroeconomic model.

It is well known that macroeconomics describes “macroeconomic studies are organized according to three types of models that describe the economic world. In different time structures, the models have respective full applicability.” According to the description of macroeconomics, the three types of models that describe the economic world are long-term models, short-term models, and medium-term models. However, the long-term models and the short-term models have not yet been clearly defined. “Almost all macroeconomists agree with the three types of models, but have different options for the length of time that each type of model is fully applicable.”

In fact, Marshall has long warned that “there is no clear boundary between ‘long term’ and ‘short term’. Naturally, in real economic life, no such boundary has been drawn; they are not needed in dealing with practical problems.” From the basic method of economics, the relationship among the three types of macroeconomic models and the correspondence between models and time factors are ambiguous, so that the macroeconomic models fall into a very embarrassing situation when applied to economic analysis.

Macroeconomics argues that output is not always produced when existing resources are fully utilized, but “output fluctuates around trend levels” under normal circumstances.

It also believes that the growth theory model can be used to analyze the long-term trend of economic growth capacity and to quantitatively determine the level of potential output.

The definition of “potential output” indicates a definite quantitative relationship between potential output of product and full employment. However, macroeconomics assumes that when the product market reaches the potential output, the labor market is in full employment. In fact, no quantitative relationship has been established between potential output and full employment, so it is difficult to accurately calculate the potential output. Output gap is an important method of macroeconomic analysis and can be used to analyze changes of economic cycle. However, due to the lack of clarity in the concept of potential output, it is unclear how to measure the output gap. Therefore, it is doubtful whether the indicator can accurately measure changes of employment to reflect changes in real economic cycle.

### SUMMARY OF THE INVENTION

The present invention is directed to the above problems, and the technical problem to be solved by the present invention is to provide a graphical method for aggregate economic analysis, which can not only scientifically analyze long-term economic development trends and changes in economic cycles of various countries, but also can more accurately analyze the direction and magnitude of the changes in the economy in the short term to provide a policy basis for governments in time to prevent and deal with economic crises, and can also provide an effective technical support for economic analysis, economic forecasting and production decision-making of various industries and organizations.

The technical solution of the present invention is a geometric graphical analysis method for economic aggregates, including the following.

Determination of Measurement Units of Economic Aggregates

Keynes “made use of only two fundamental units of quantity, namely, quantities of moneyvalue and quantities of employment” in the analysis of economic aggregates.

Keynes chose to measure the total employment of a country by use of its total gross wage. “We shall call the unit in which the quantity of employment is measured as the labor-unit; and the money-wage of a labor-unit is called the wage-unit. Thus, if E is the wages (and salaries), W is the wage-unit, and N is the quantity of employment; where E=N·W.”

Nominal Wage-Unit and Real Wage-Unit

W represents a nominal average wage (nominal wage-unit); P represents a consumer price index; W̅ represents a real average wage (real wage-unit); where W̅=W/P.

Employment Measured in the Real Wage-Unit

At time t, employment measured in the real wage-unit is defined as

Nₜ^{w}=Nₜ·W̅ₜ (1)

The equation shows that at each time point t, the employment measured in the real wage-unit Nₜ^{w} is equal to the product of employment Nₜ and the real average wage W̅ₜ at the time point, and equal to the real gross wage of a country.

Labor Supply-Demand Model Measured in Wage-Unit (NS-ND Model)

According to the fundamental measurement units, labor-unit, money-unit and time-unit selected by Keynes, based on the Keynes's labor supply and labor demand model, we construct a model of labor supply-demand equilibrium measured in the real wage-unit.

In FIG. 1, the vertical axis is the real wage index W^{t}/P (Wi t represents the nominal wage index), and the horizontal axis is employment N^{w} measured in the real wage-unit, Nₜ^{w}; where Nₜ^{w}=Nₜ·W̅ₜ. The labor supply curve and the labor demand curve measured in the real wage-unit are respectively NS and ND, which are functions of the real wage index. According to Keynes's assumptions, the labor supply curve is unchanged in the short term, the lower end of the labor supply curve is horizontal, and changes in the price level only affect the movements of the labor demand curve.

One major difference between FIG. 1 and the conventional model lies in that its abscissa is the employment N^{w} measured in the real wage-unit, rather than the employment N. At time t, when the labor supply and demand are equilibrated, an equilibrium employment Nₜ^{w} and a real wage level Wi t/Pₜ are determined from the intersection of the labor supply curve NS and the labor demand curve ND. The labor supply-labor demand model for describing the relationship between the employment N^{w} measured in the real wage-unit and the real wage index/IP is called a NS-ND model.

Aggregate Supply and Aggregate Demand Model (AS-AD Model)

Keynes's aggregate supply function and aggregate demand function are defined as: “Z is the aggregate supply price of the output from employing N men, and then the relationship between Z and N is written as Z=Φ(N), which can be called the aggregate supply function. Similarly, let D be the proceeds which entrepreneurs expect to receive from employing N men, the relationship between D and N being written D=f(N), which can be called the aggregate demand function.” According to Keynes's assumptions, the aggregate supply function is constant in the short term.

In FIG. 2, the vertical axis is price P, the horizontal axis is gross output (or gross income), and the aggregate supply and the aggregate demand are respectively AS=Φ(N) and AD=ƒ(N), which are functions of the employment N. At time t, when the product market is in equilibrium, the aggregate supply AS is equal to the aggregate demand AD, the gross output is Yₜ, the price level is Pₜ, and the corresponding employment is Nₜ.

Keynes's aggregate supply-aggregate demand model can be abbreviated as an AS-AD model. The AS-AD model can be used to quantitatively investigate the relationship between effective demand and equilibrium employment of a country, and the relationship between labor wage and labor product value.

Relationship Between AS-ND Model and AS-AD Model

According to Keynes's analysis method, we can link the AS-AD model with the NS-ND model, and use a unified graph to describe equilibrium of labor supply and demand and product supply and demand at the same time.

FIG. 3 shows the relationship between the AS-AD model and the NS-ND model.

When the labor market is in an equilibrium state, the corresponding product market is also in an equilibrium state. The purpose of economic aggregate analysis is to construct a general model of supply-demand equilibrium based on the unified analysis on the interaction between the labor supply-labor demand model and the aggregate supply-demand model, so as to find a relationship between labor supply-demand equilibrium point El t and product supply-demand equilibrium point Ey t, that is, a relationship between equilibrium employment and effective demand (equilibrium output).

Construction of a 4D Model of Supply and Demand

In the relationship graph of the NS-ND model and the AS-AD model (FIG. 3), the AS-AD model is rotated 180 degrees leftward about the vertical axis (i.e., P coordinate), and shares a vertical axis with the NS-ND model to obtain a combined graph of the NS-ND model and the AS-AD model. In the graph, the product supply-demand graph is rotated 90 degrees forward about the vertical axis (P coordinate) to form a 3D space graph composed of three coordinate axes.

The x coordinate of the graph represents employment N^{w} measured in the real wage-unit, the y coordinate represents real gross output (or real gross income) Y, the z coordinate represents nominal wage/price (Wⁱ/P), each coordinate variable of the 3D space graph is determined by the time coordinate t, and a 4D model of supply and demand is thus formed. We call the graph composed of time (t) and 3D space using employment (N^{w}) as x axis, gross output (Y) as y axis and wage/price (W^{t}/P) as z axis as a 4D model of supply and demand, or a N^{w}-Y-W^{t}/P 4D model.

In FIG. 4, point Eₜ(Nₜ^{w}, Yₜ^{d}, Wₜⁱ/P) reflects a supply-demand equilibrium state of an economy at time t. Point Eₜ is a point constituted by the labor supply-demand equilibrium point and the product supply-demand equilibrium point in 3D space. Point Eₜ indicates that, at time t, when the labor supply and demand and the product supply and demand are in equilibrium, the equilibrium employment measured in the real wage-unit, the real value of effective demand (gross output or gross income), the nominal wage index, and the price index are respectively Nₜ^{w}, Yₜ^{d}, Wₜⁱ, Pₜ. The point consisting of employment, gross output, and nominal wage/price reflects the overall situation of a country's supply-demand equilibrium.

Three Interconnected Models of Supply and Demand

The plane development of the 3D space graph is composed of three planes thereof, respectively a front plane of the 3D space graph (N^{w}-Wⁱ/P graph), i.e., the labor supply-demand model (NS-ND model); a side plane (Y-P graph). i.e., the product aggregate supply and aggregate demand model (AS-AD model); and a bottom plane (N^{w}-Y^{d} graph), which describes the equilibrium employment and effective demand model (N^{w}-Y^{d} graph) reflecting the general relationship of supply-demand equilibrium.

N^{w}-Y^{d} Model of Supply-Demand Equilibrium

The bottom plane of the 4D model of supply and demand is a N-Y^{d} model of supply-demand equilibrium. For the convenience of observation, we can rotate the bottom plane of the 3D space graph 90 degrees upwards around the horizontal axis (i.e., N^{w} coordinate). In the N^{w}-Y^{d} model obtained (FIG. 5), the horizontal axis represents employment N^{w} measured in the real wage-unit, and the vertical axis represents real value Y^{d} of effective demand. The model describes, in a supply-demand equilibrium state at each time point, the relationship between the employment measured in the real wage-unit and the effective demand, and the optimal state of the economy.

The basic characteristic of the N^{w}-Y^{d} model of supply-demand equilibrium shows that the N^{w}-Y^{d} model consists of two continuous supply-demand equilibrium curves. The locus of points representing equilibrium employment and effective demand at different time points forms a continuous supply-demand equilibrium curve. The 4D model presents in the space a connecting line of points constituted by equilibrium employment and effective demand in different periods, and the projection of the line on the bottom plane of the 3D space graph is called a supply-demand equilibrium curve. The other continuous supply-demand equilibrium curve is a full employment curve, which is the projection of the full employment curve of the NS-ND model on the N^{w}-Y^{d} model.

Connecting Line of 4D Model of Supply and Demand and “Short-Term” Equilibrium Point

FIG. 6 shows an extension of the connecting line of points constituted by equilibrium employment and effective demand caused by the movement of the aggregate demand curve and the labor demand curve in the 4D model, reflecting short-term changes in the supply-demand equilibrium curve.

In the short term, an assumption that the elasticity of the labor supply curve and the aggregate supply curve is given is made. When the aggregate demand curve moves outward, because the increase in effective demand usually leads to an increase in labor demand, the labor demand curve also moves outward. Thus, the intersection of the aggregate supply curve and the aggregate demand curve moves outward from Eₜ₋₁^{y} to Eₜ^{y}. At the same time, the intersection of the labor supply curve and the labor demand curve moves outward from Eₜ₋₁^{l} to Eₜ^{l}. The change in employment and effective demand over time is reflected in the 4D model as the supply-demand equilibrium point moves outward from Eₜ₋₁ to Eₜ, thus forming a connecting line from point Eₜ₋₁ to point Eₜ. The connecting line of supply-demand equilibrium points is projected to the N^{w}-Y^{d} model, showing that the connecting line of points constituted by equilibrium employment and effective demand moves outward from Eₜ₋₁ⁿ to Eₜⁿ. The short-term supply-demand equilibrium points are connected to obtain a connecting line of points constituted by supply-demand equilibrium points in the labor market and supply-demand equilibrium points in the product market, i.e., a supply-demand equilibrium curve.

Supply-Demand Equilibrium Curve in N^{w}-Y^{d} Model of Supply-Demand Equilibrium

The points Eₜ₋ₙⁿ . . . Eₜ₋₂ⁿ, Eₜ₋₁ⁿ, Eₜⁿ constituted by equilibrium employment and corresponding effective demand in different periods are connected to form a continuous curve composed of points constituted by equilibrium employment and effective demand. We define the curve as a supply-demand equilibrium curve, abbreviated as an equilibrium curve, expressed by Nₜ^{y}. The supply-demand equilibrium curve is the projection of the connecting line of the supply-demand equilibrium points in 3D space on the N^{w}-Y^{d} model, reflecting continuous changes in economic aggregate with time.

Definition of Wage-Income Ratio

Wage-income ratio gₜ of a country at time t is defined as a ratio of gross wage Eₜ to gross income Yₜ at that time, that is,

gₜ=Eₜ/Yₜ (2)

Relationship Between Equilibrium Employment and Effective Demand

Because Eₜ=Nₜ·W̅ₜ=Nₜ^{w} (1) and Yₜ^{d}=Yₜ, the relationship between equilibrium employment and effective demand can be obtained from equation (2), that is,

Yₜ^{p}=(1/gₜ)Nₜ^{w} (3)

Where Yₜ^{d} represents effective demand, gₜ represents wage-income ratio, and Nₜ^{w} represents equilibrium employment (measured in the real wage-unit), assuming that gₜ is a constant in the short term.

Under the assumption that the wage-income ratio gₜ is a constant, the equilibrium employment is proportional to the effective demand; in the real economy, the equilibrium employment is generally positively correlated to the effective demand.

Basic Characteristics of the Supply-Demand Equilibrium Curve

The supply-demand equilibrium curve has three basic characteristics, including position, extension and slope of the supply-demand equilibrium curve.

Position of the Supply-Demand Equilibrium Curve

In the N^{w}-Y^{d} model, the position of the supply-demand equilibrium curve Nₜ^{y} refers to coordinates of point Eₜⁿ constituted by equilibrium employment Nₜ^{w} and corresponding effective demand Yₜ^{d}, that is, the equilibrium employment Nₜ^{w} and the effective demand Yₜ^{d} uniquely determine the position of the supply-demand equilibrium curve Nₜ^{y}.

The change in the position of a supply-demand equilibrium point is caused by the change in the employment relative to the effective demand over time. At time t, the equilibrium employment Nₜ^{w} and the corresponding effective demand Yₜ^{d} constitute a new equilibrium point Eₜⁿ(Nₜ^{w},Yₜ^{d}). Point Eₜ₋₁ⁿ on the supply-demand equilibrium curve Nₜ₋₁^{y} at time t−1 is connected to point Eₜⁿ to obtain the supply-demand equilibrium curve Nₜ^{y} at time t. If we use the coordinates of point Eₜⁿ to express the position of the supply-demand equilibrium curve Nₜ^{y}, the position of the supply-demand equilibrium curve moves from point Eₜ₋₁ⁿ to point Eₜⁿ from time t−1 to time t.

Slope of the Supply-Demand Equilibrium Curve

Slope of the supply-demand equilibrium curve is defined as the ratio of the change in employment to the change in effective demand from time t−n to time t.

Sₜⁿ=(Nₜ^{w}−Nₜ₋ₙ^{w})/(Yₜ^{d}−Yₜ₋ₙ^{d}) (4)

Where Sₜⁿ represents the slope of the supply-demand equilibrium curve from time t−n to time t, Nₜ^{w} and Nₜ₋ₙ^{w} respectively represent equilibrium employment at time t and time t−n, and Yₜ^{d} and Yₜ₋ₙ^{d} respectively represent effective demands at time t and time t−n.

In a certain period, the slope of the supply-demand equilibrium curve reflects the growth rate of employment measured in the real wage-unit relative to effective demand, and can be used to describe long-term changes in employment. Under the condition of increasing effective demand, the slope Sₜⁿ of the supply-demand equilibrium curve exists in three cases:

When Sₜⁿ>0, the supply-demand equilibrium curve tilts to the right, which means that during the period, when the effective demand increases, the employment also increases. If the value of Sₜⁿ is small, the employment measured in the real wage-unit increases slowly relative to the effective demand; if the value of Sₜⁿ is large, the employment and the real average wage increase fast relative to the effective demand.

When Sₜⁿ=0, the supply-demand equilibrium curve is vertical, which means that when the effective demand increases, the employment and the real average wage remain unchanged for a long term.

When Sₜⁿ<0, the supply-demand equilibrium curve tilts to the left, which means that in a long term, when the effective demand increases, the employment decreases. The larger the absolute value of Sₜⁿ is, the greater the decrease in employment and real average wage relative to the increase in effective demand is.

Extension of the Supply-Demand Equilibrium Curve

In the N^{w}-Y^{d} model, when the point constituted by equilibrium employment and effective demand moves from Eₜ₋₁ⁿ to Eₜⁿ, the equilibrium curve changes from Nₜ₋₁^{y} to Nₜ^{y}. The short-term change of the equilibrium curve over time is called an extension of the supply-demand equilibrium curve. The extension of the equilibrium curve describes the change in the employment measured in the real wage-unit relative to the real effective demand over time, which reflects the short-term change in the supply-demand equilibrium curve.

The extension of the supply-demand equilibrium curve is described by two indicators: the change in employment ΔNₜ^{w} and the change in effective demand ΔYₜ^{d}:

ΔNₜ^{w}=Nₜ^{w}−Nₜ₋₁^{w} (5)

ΔYₜ^{d}=Yₜ^{d}−Yₜ₋₁^{d} (6)

From time t−1 to time t, regardless of the value of the change in effective demand ΔYₜ^{d}, the change in employment determines the extension direction of the equilibrium curve. Under the condition of increasing effective demand, 1) when ΔNₜ^{w}>0, the employment increases, and the supply-demand equilibrium curve extends to the upper right; 2) when ΔNₜ^{w}>0, the employment is unchanged, and the supply-demand equilibrium curve extends upwards; 3) when ΔNₜ^{w}<0, the employment decreases, and the supply-demand equilibrium curve extends to the upper left.

4D Graphical Method and Full Employment Equilibrium

By using a 4D graphical method, we can find out an output level of the product market in stable equilibrium from equilibrium points of full employment of the labor market in different periods, thus obtaining a connecting line of supply-demand equilibrium points associated with “stable equilibrium”.

As shown in FIG. 7, at time t, the labor market is in full employment equilibrium, and the labor supply curve and the labor demand curve intersect in the short-term fill employment vertical line Nₜ^{w*}. The projection of the full employment curve Nₜ^{w*} of the NS-ND model at time t to the N^{w}-Y^{d} model and the extension line of the full employment curve Nₜ₋₁^{y*} at time t−1 intersect at point Eₜ^{n*} to form a full employment curve Nₜ^{y*} at time t, thus obtaining a stable equilibrium output Y*ₜ of the product market corresponding to point Eₜ^{n*} at the time t. In the AS-AD model, the aggregate supply curve and the aggregate demand curve intersect in the vertical line Y*ₜ of short-term stable equilibrium output. At the time, the full employment equilibrium point Nₜ^{l*} of the labor market and the stable equilibrium point Nₜ^{y*} of the product market constitute point E*ₜ in 3D space. Point E*ₜ(Nₜ^{w*}, Y*ₜ, Wₜⁱ/Pₜ) reflects a stable equilibrium state of an economy at time t, which indicates that when the labor market reaches full employment equilibrium and the product market reaches stable equilibrium, the employment measured in the real wage-unit, the real gross output, the nominal wage index and the general price index are respectively Nₜ^{w*}, Y*ₜ, Wₜⁱ, Pₜ.

Full Employment Curve in N^{w}-Y^{d} Model of Supply-Demand Equilibrium

In the N^{w}-Y^{d} model of supply-demand equilibrium, from time t−n to time t, the points constituted by full employment measured in the real wage-unit and real output of stable equilibrium are respectively Eₜ₋ₙ^{n*} (Nₜ₋ₙ^{w*}, Yₜ₋ₙ^{*})* Eₜ₋₂^{n*}(Nₜ₋₂^{w*}Yₜ₋₂^{*}), Eₜ₋₁^{n*} (Nₜ₋₁^{*}, Yₜ₋₁^{*}), Eₜⁿ(Nₜ^{w*},Yₜ^{*}). The points are connected to form a continuous connecting line of points constituted by full employment and stable equilibrium gross output at different time. We define the curve as a curve of full employment and stable equilibrium output, abbreviated as a full employment curve, expressed by Nₜ^{y*}. The fail employment curve is the projection of the connecting line of supply-demand equilibrium points E*ₜ₋ₙ . . . E*ₜ₋₂, E*ₜ₋₁, E*ₜ in the 3D space graph on the N^{w}-Y^{d} model, and reflects fail employment and corresponding equilibrium output if the labor market reaches full employment at each time point.

When the labor market is in full employment, the supply-demand equilibrium curve Nₜ^{y} and the full employment curve Nₜ^{y*} intersect at one point, and the output level corresponding to the equilibrium point is an equilibrium output corresponding to full employment. We define the output level corresponding to full employment as a stable equilibrium output, expressed by Yₜ^{*}.

Model of Full Employment

At time t, if full employment is not achieved, some assumptions about real wage are required for determining the full employment measured in the real wage-unit. If the real employment is not very different from the full employment, we can assume that the real average wage is unchanged before full employment is achieved, if the real employment is greatly different from the full employment, the real wage increases with the increase in employment, and a rising coefficient of real wage needs to be determined according to the slope of the labor supply curve.

Nₜ^{w*}=vₜWₜNₜ^{*} (7)

Where Nₜ^{w*} represents full employment measured in the real wage-unit, w represents real wage rising coefficient, W̅ₜ represents real average wage, and Nₜ^{*} represents full employment.

Model of Potential Output

According to the relationship between equilibrium employment and effective demand: Yₜ^{d}=(1/gₜ) Nₜ^{w} (3), the level of potential output Y^{p} can be obtained from the value of fill employment Nₜ^{w*}, and the relationship between the two can be given by the following model.

Yₜ^{p}=(1/gₜ^{*})ΔNₜ^{w*} (8)

Where Yₜ^{*} represents the potential output; g*ₜ represents an optimal wage-income ratio; and Nₜ^{w*} represents the full employment. The optimal wage-income ratio is assumed to be a constant.

Equation (8) shows that a quantitative relationship exists between potential output and full employment under the assumption that g*ₜ is a constant. Thus, we draw two preliminary conclusions: 1) the potential output is linked to optimal income distribution; and 2) the potential output depends on the full employment. Under a set optimal wage-income ratio, when the full employment is determined, the potential output can be determined uniquely.

Basic Characteristics of the Full Employment Curve

The full employment curve has three basic characteristics, including position, slope and extension of the full employment curve.

Position of the Full Employment Curve

At time t, when the labor market achieves full employment equilibrium, the full employment vertical line Nₜ^{w*} and the extension line of the full employment curve Nₜ₋₁^{y*} at time t−1 intersect at point Eₜ^{n*} thus forming a full employment curve Nₜ^{y*} at time t. At the time, the gross output level corresponding to point Eₜ^{n*} is a potential output Yₜ^{p} at time t, given by Yₜ^{p}=(1/gₜ^{*}) Nₜ^{w*} (8). If we use the coordinates of point Eₜ^{n*} to express the position of the full employment curve Nₜ^{y*}, from time t−1 to time t, the position of the full employment curve moves from point Eₜ₋₁^{n*} to point Eₜ^{n*}. As the values of the full employment and the change in potential output over time, the position of the full employment curve also changes.

Slope of the Full Employment Curve

Slope of the full employment curve is defined as the ratio of the change in full employment to the change in potential output from time t−n to time t.

Sₜ^{n*}=(Nₜ^{w*}−Nₜ₋ₙ^{w*})/(Yₜ^{p}−Yₜ₋ₙ^{p}) (9)

Where Sₜ^{n*} represents the slope of the full employment curve from time t−n to time t, Nₜ^{w*} and Nₜ^{w*} respectively represent full employment at time t and time t−n. Yₜ^{p} and Yₜ₋ₙ^{p} respectively represent potential outputs at time t and time t−n.

In a certain period, the slope of the full employment curve reflects the growth rate of labor supply relative to potential output, and can be used to describe long-term changes in labor supply. Under the condition of increasing potential output, the slope Sₜ^{n*} of the full employment curve exists in three cases:

When Sₜ^{n*}>0, the labor supply increases; if the value of Sₜ^{n*} t is small, in the long term, the full employment measured in the real wage-unit increases slowly relative to the increase in potential output.

When Sₜ^{n*}=0, the labor supply is unchanged, which means that in the long term, the full employment remains unchanged.

When Sₜ^{n*}<0, the labor supply decreases; the larger the negative value of Sₜ^{n*} is, the greater the decrease in long-term labor supply and real average wage relative to the increase in potential output is.

Extension of the Full Employment Curve

From time t−1 to time t, the full employment equilibrium point moves from Eₜ₋₁^{n*} to Eₜ^{n*}, causing the full employment curve to change from Nₜ₋₁^{y*} to Nₜ₋₁^{y*}. We call the short-term change of the full employment curve over time as an extension of the full employment curve. The extension of the full employment curve describes the change in full employment in the real wage-unit relative to potential output over time, reflecting the short-term characteristics of the full employment curve.

The extension of the full employment curve is described by two indicators: the change in full employment ΔNₜ^{w*} and the change in potential output ΔYₜ^{p}

ΔNₜ^{w*}=Nₜ^{w*}−Nₜ₋₁^{w*} (10)

Equation (10) shows that the change in full employment depends on short-term changes in full employment and real average wage; the change in full employment associated with the short-term change in labor force is not only closely related to the natural growth rate of a country's population, but also is closely related to a country's labor supply policy, involving the movement of a short-term labor supply curve;

ΔYₜ^{p}=Yₜ^{p}−Yₜ₋₁^{p} (11)

Under the condition that the set optimal wage-income ratio is a constant, the change in potential output depends on the change in full employment; Yₜ^{p}=(1/gₜ^{*})Nₜ^{w*} (8) is substituted into (11) to approximately obtain the following relationship;

ΔYₜ^{p}=(1/gₜ^{*})ΔNₜ^{w*} (12)

Where ΔYₜ^{p} represents the change in potential output from time t−1 to time t, gₜ^{*} represents the optimal wage-income ratio, ΔNₜ^{w*} represents the change in full employment, and gₜ^{*} is assumed to be a constant.

Calculation Method of Labor Supply-Labor Demand Model and Employment

According to different natures of unemployment, Keynes divided unemployment into “frictional” unemployment, “voluntary” unemployment, and involuntary unemployment. The sum of “frictional” unemployment, “voluntary” unemployment and “full” employment of a country is equal to the total labor force of the country.

At time t, assumptions that Nₜ represents employment, Nₜ^{*} represents full employment. Nₜ^{*} represents unemployment, Nₜ^{*} represents “voluntary” unemployment (including frictional unemployment), ΔNₜ represents the change in employment, and Nₜⁱ represents labor force are made. The sum of the full employment Nₜ^{*} and the “voluntary” unemployment Nₜ^{*} is equal to the labor force, i.e.

Nₜ^{*}=Nₜ^{I}−Nₜ^{*} (13)

The sum of the real employment Nₜ and the unemployment Nₜ^{v} is equal to the full employment Nₜ^{*}, i.e.

Nₜ=Nₜ^{*}−Nₜ^{u} (14)

Equilibrium employment and real wage can be obtained on the basis of the model of labor supply and labor demand. According to various economic aggregates measured in wage units, selected by Keynes, i.e., gross output and employment measured in the real wage-unit, the two variables different natures are unified to investigate the quantitative relationship between the two, which can be described by the supply-demand equilibrium curve.

Calculation Method of N^{w}-Y^{d} Model of Supply-Demand Equilibrium and Employment

The sum of the full employment Nₜ^{w*} and the “voluntary” unemployment Nₜ^{*} is equal to the labor force Nₜ^{*}, i.e.,

Nₜ^{w*}=Nₜ^{*}−Nₜ^{w*} (15)

The sum of the real employment Nₜ^{w} and the unemployment Nₜ^{*} is equal to the full employment Nₜ^{w*}, i.e.,

Nₜ^{w}+Nₜ^{*v}=Nₜ^{w*} (16)

Selection of Time Unit for N^{w}-Y^{d} Model of Supply-Demand Equilibrium

As far as the N^{w}-Y^{d} model is concerned, the accuracy of the supply-demand equilibrium curve is closely related to the time unit. The smaller the time unit is, the higher the accuracy of the supply-demand equilibrium curve is, which means that the difference between the results shown by the supply-demand equilibrium curve and the real observed economic facts is relatively small.

The time unit of the short-term model is one year or one quarter, or even one month or one day. The small time unit of the short-term model helps to improve the accuracy of economic analysis, and is crucial to improve the data statistic and processing abilities. The time unit of the long-term model is five years or even longer. The long-term analysis on the supply-demand equilibrium curve should be continuous. In general, we can discuss the supply-demand equilibrium curve in stages according to different slopes.

Long-Term Analysis Method for Slope of Supply-Demand Equilibrium Curve Relative to Full Employment Curve

In n time period, general assumptions that the slopes of the supply-demand equilibrium curve and the full employment curve are both more than or equal to zero, that is, Sₜⁿ≥0 and Sₜ^{n*}≥0, are made. The slope of the supply-demand equilibrium curve relative to the full employment curve exists in the following four cases (FIG. 7):

In the first state, the supply-demand equilibrium curve coincides with the full employment curve, and the economy is in a stable equilibrium state for a long term.

In the N^{w}-Y^{d} model, the basic characteristics of full employment equilibrium are: in the short term, the supply-demand equilibrium curve intersects with the full employment curve, that is, Nₜ^{w}=Nₜ^{w*} in the long term, the slopes of the supply-demand equilibrium curve and the full employment curve are equal, and the two equilibrium curves coincide, reaching a long-team stable equilibrium state, that is, Sₜⁿ=Sₜ^{n*} and Nₜ^{w}=Nₜ^{w*}. From time t−n to time t, if the supply-demand equilibrium curve Nₜ^{y} fluctuates around the full employment curve Nₜ^{y*} within a given range, the economy achieves full employment equilibrium in the period.

In the second state, in the presence of unemployment, if the slope of the supply-demand equilibrium curve is equal to the slope of the full employment curve, the employment rate is relatively stable for a long term.

“When N is smaller than its maximum value, the employment is in a neutral equilibrium state”, at which time the supply-demand equilibrium curve is on the left of the full employment curve. When Sₜⁿ=Sₜ^{n*} and Nₜ^{w}<Nₜ^{w*}ₜ* the employment gap and the output gap remain unchanged. Generally, if the real wage grows stably during the time period, the employment rate remains unchanged.

In the third state, in the presence of unemployment, if the slope of the supply-demand equilibrium curve is greater than the slope of the full employment curve, the employment rate gradually rises.

When Sₜⁿ>Sₜ^{n*} and Nₜ^{w}<Nₜ^{w*}, the employment gap gradually shrinks, and the output gap also shrinks. Generally, the real wage and the employment rate increase during the time period. As for the increase rate of the employment rate, the relative change in the slope of the supply-demand equilibrium curve and the slope of the full employment curve needs to be calculated.

In the fourth state, if the slope of the supply-demand equilibrium curve is smaller than the slope of the full employment curve, the employment rate of a country continues to decrease.

When Sₜⁿ<Sₜ^{n*} and Nₜ^{w}<Nₜ^{w*}, the employment gap expands, and the output gap also expands. In general, the employment rate continues to decrease during the time period. Macroeconomics generally believes that “Output is not always at its trend level, and vice versa, output fluctuates around the trend level.” However, the real employment may be neither at the trend level of full employment, nor fluctuates around the trend level of full employment. In the N^{w}-Y^{d} model, the basic characteristic of long-term unemployment lies in that the slope of the supply-demand equilibrium curve is smaller than the slope of the full employment curve, or the supply-demand equilibrium curve gradually deviates from the trend level of full employment. As the employment gap expands, the employment rate continues to decrease and the economy is likely to fall into great depression.

Supply-Demand Equilibrium Curve and Income Distribution

At time t, the real gross wage Eₜ=Nₜ W̅ₜ is equal to the employment Nₜ^{w}=Nₜ W̅ₜ measured in the real wage-unit, and the real gross income Yₜ is equal to the real effective demand Y^{d}. Thus, the equilibrium point Eₜⁿ(Nₜ^{w},Yₜ^{d}) on the supply-demand equilibrium curve indicates not only the proportional relationship between the equilibrium employment Nₜ^{w} and the effective demand Yₜ^{d}, but also the proportional relationship between the real gross wage Eₜ(=Nₜ W̅ₜ) and the real gross income Yₜ, that is, the wage-income ratio: gₜ=Eₜ/Yₜ (2).

The point constituted by the labor supply-demand equilibrium point and the product supply-demand equilibrium point measured in the real wage-unit is a concept related to the wage-income ratio. In the sense, an important characteristic of the equilibrium point in the N^{w}-Y^{d} model of supply-demand equilibrium is to reflect the status of income distribution in a country.

Changes in the Slope of the Supply-Demand Equilibrium Curve and the Income Distribution

From time t−n to time t, the change in wage-income ratio is expressed as (Nₜ^{w}−Nₜ₋ₙ^{*})/(Yₜ^{d}−Yₜ₋ₙ^{d}), and the slope of the supply-demand equilibrium curve is Sₜⁿ=(Nₜ^{w}−Nₜ₋ₙ^{w})/(Yₜ^{d}−Yₜ₋ₙ^{d}) (4), that is, the slope of the supply-demand equilibrium curve in a certain period reflects the change trend of the wage-income ratio. By analyzing the change in the slope of the supply-demand equilibrium curve in a country, the change in ratio of gross wage to gross income in the country can be quantitatively investigated.

Under the condition of increasing effective demand of a country, the positive and negative signs of the slope of the supply-demand equilibrium curve reflect that the supply-demand equilibrium curve change in three situations:

When Sₜⁿ>0, the supply-demand equilibrium curve tilts to the upper right, and the increase in effective demand at the time promotes the increase in employment. The value of Sₜⁿ reflects the degree of change in wage-income ratio. If Sₜⁿ>gₜ₋ₙ. (wage-income ratio at time t−n), the wage-income ratio increases; if Sₜⁿ=gₜ₋ₙ, the wage-income ratio is unchanged; if Sₜⁿ<gₜ₋ₙ, the wage-income ratio decreases.

When Sₜⁿ=0, the supply-demand equilibrium curve is vertical upwards, no matter how the effective demand increases, the employment is unchanged, and the wage-income ratio is also unchanged.

When Sₜⁿ<0, the supply-demand equilibrium curve tilts to the upper left. As the effective demand increases, the employment decreases, and the wage-income ratio decreases sharply. The absolute value of Sₜⁿ reflects the degree of decrease in the wage-income ratio.

Analysis Method for “Employment Gap”

At time t, the “involuntary” unemployment (employment gap) Nₜ^{wu} is equal to the difference between the full employment Nₜ^{w*} and the real employment Nₜ^{w}, and we call the difference as employment gap, i.e.,

Nₜ^{w*}=Nₜ^{w*}−Nₜ^{w} (17)

In the N^{w}-Y^{d} model of supply-demand equilibrium, the employment gap appears as the horizontal distance between the supply-demand equilibrium curve Nₜ^{y} and the full employment curve Nₜ^{y*}.

For the N^{w}-Y^{d} model of supply-demand equilibrium, the basic characteristics of the employment gap are described as follows:

When Nₜ^{wu}>0, Nₜ^{w}<Nₜ^{w*}, a certain distance exists between the supply-demand equilibrium curve and the full employment curve, and certain “involuntary” unemployment exists in the economy, or employment gap exists, the economy is in a normal non-full employment state. The larger the employment gap is, the higher the social unemployment rate is.

When Nₜ^{wu}=0, Nₜ^{w}=Nₜ^{w*}, the supply-demand equilibrium curve and the full employment curve intersect at one point, and the economy does not have “involuntary” unemployment, and is in an ideal full employment state.

When Nₜ^{wu}<0, Nₜ^{w}>Nₜ^{w*}, the supply-demand equilibrium curve and the full employment curve have intersected before time t. At time t, the supply-demand equilibrium curve is at the upper right of the full employment curve, and the economy is in a special overemployment state.

Analysis Method for “Output Gap”

At time t, the gap between the effective demand and the potential output Yₜ^{pd} is equal to the difference between the potential output Yₜ^{p} corresponding to the full employment state and the effective demand Y^{d}ₜ, i.e.,

Yₜ^{pd}=Yₜ^{p}−Yₜ^{d} (18)

In the N^{w}-Y^{d} model of supply-demand equilibrium, the output gap appears as the vertical position of the supply-demand equilibrium curve Nₜ^{y} relative to the full employment curve Nₜ^{y*}.

Relationship Between Output Gap and Employment Gap

Yₜ^{d}=(1/gₜ) Nₜ^{w} (3) and Yₜ^{p}=(1/gₜ^{*})Nₜ^{w*} (8) are substituted into (18) to obtain

$${Y}_{t}^{pd} = \frac{1}{{g}_{t}} \cdot {N}_{t}^{{wu}^{*}} \qquad ( 19 )$$

Where Ypd t represents output gap, gₜ represents wage-income ratio, and Nₜ^{*u*} represents adjusted employment gap.

$${g}_{t}^{*} = {v}_{t} \cdot {g}_{t} , {N}_{t}^{{wu}^{*}} = \frac{1}{{v}_{t}} \cdot {N}_{t}^{{w}^{*}} - {N}_{t}^{w} ,$$

v₂ represents a rising coefficient of the wage-income ratio.

From equation (19), under the condition that the short-term wage-income ratio gₜ is assumed to be umchanged, the value of the output gap Yₜ^{pd} depends on the value of the adjusted employment gap Nₜ^{*v*}.

Extension of Supply-Demand Equilibrium Curve and Employment Gap

From Nₜ^{wu}=Nₜ^{w*}−Nₜ^{w} (17), at time t, the change in the employment gap measured in the real wage-unit is given by the following equation.

ΔNₜ^{w*}=ΔNₜ^{w*}−ΔNₜ^{w*} (20)

Where ΔNₜ^{wu} represents the change in employment gap (measured in the real wage-unit). ΔNₜ^{wu} represents the change in full employment, and ΔNₜ^{w} represents the change in employment.

In the N^{w}-Y^{d} model of supply-demand equilibrium, the short-term change in real employment depends on the direction and magnitude of extension of the supply-demand equilibrium curve relative to extension of the full employment curve, that is, depends on the change in real employment relative to full employment. Under the assumption of ΔNₜ^{w*}≥0, three possibilities for the change in employment gap due to the difference in the direction and magnitude of extensions of the supply-demand equilibrium curve and the full employment curve are caused:

When ΔNₜ^{wu}=0, ΔNₜ^{w}=ΔNₜ^{w*}, the increase in real employment is smaller than the increase in full employment, and the employment gap expands, which means that the increase in labor demand is smaller than the increase in labor supply, and the employment rate in a country declines.

When ΔNₜ^{wu}=0, ΔNₜ^{w}=ΔNₜ^{w*}, the change in real employment is equal to the change in full employment, and the employment gap does not change, which means that the change in labor demand is equal to the change in labor supply in the short term.

When ΔNₜ^{wu}<0, ΔNₜ^{w}>ΔNₜ^{w*}, the increase in real employment is greater than the increase in full employment, and the employment gap shrinks, which means that the increase in labor demand is greater than the increase in labor supply, and the employment rate in a country rises.

Extension directions of the supply-demand equilibrium curve and the short-term equilibrium state

The short-term model usually assumes that “other conditions are constant”. We can assume that the full employment curve extends with certain slope in a short term. The distance between the supply-demand equilibrium curve and the full employment curve depends mainly on the extension direction and extension amplitude of the supply-demand equilibrium curve. Thus, the key to short-term economic analysis is to “trace” how the supply-demand equilibrium curve extends.

FIG. 8 shows changes in different extension directions of the supply-demand equilibrium curve and in the employment gap. We can see that the change in the employment gap depends first on the extension direction of the supply-demand equilibrium curve, and second on the extension amplitude of the supply-demand equilibrium curve.

In the case of unemployment, the supply-demand equilibrium curve and the full employment curve continue to extend in the short term, and the distance between the supply-demand equilibrium curve and the full employment curve change constantly, which leads to different supply-demand equilibrium states, i.e., increase in employment, constant employment and decrease in employment, from the perspective of employment. In general, different extension directions and magnitudes of the supply-demand equilibrium curve lead to at least four possibilities for changes in the employment gap:

First, the supply-demand equilibrium curve Nₜ^{y} extends to the upper right, which includes three cases.

If the increase in real employment is greater than the increase in full employment, the change in the employment gap ΔNₜ^{wu} is negative, the employment gap shrinks, and the output gap also shrinks.

If the state continues, the supply-demand equilibrium curve and the full employment curve Nₜ^{y*} intersect at a point for a long term, and the economy achieves full employment equilibrium. Under the condition of full employment, it is difficult to further increase the output by further increasing the employment.

According to different slopes of the equilibrium curve, the increase in real employment is possibly smaller than or equal to the increase in full employment. At the time, the change in employment gap is ΔNₜ^{wu}≥0.

Second, the supply-demand equilibrium curve Nₜ^{*y} extends vertically upwards, the full employment increases while the real employment does not change, the change in employment gap ΔNₜ^{wu} is positive, the employment gap expands, and the output gap also expands.

Third, the supply-demand equilibrium curve Nₜ^{*y} extends to the upper left, the full employment increases but the real employment decreases, the change ΔNₜ^{wu} in employment gap is positive, the employment gap expands, and the output gap also expands.

Fourth, the supply-demand equilibrium curve Nₜ^{*y} extends to the lower left, the full employment increases but the real employment and the output decrease simultaneously the change ΔNₜ^{wu} in employment gap is positive, and the employment gap and the output gap expand simultaneously. The decrease in effective demand causes the unemployment rate to rise, leading to an alternate decrease in wages and price levels. If the effective demand of a country continues to decrease and the unemployment rate continues to increase, an economic crisis is likely to occur.

### BRIEF DESCRIPTION OF THE DRAWINGS

In order to describe the technical solutions in the embodiments of the present invention or in the prior art more clearly, the following briefly introduces the accompanying drawings required for describing the embodiments or the prior art.

Apparently, the accompanying drawings in the following description show only some embodiments of the present invention, and a person of ordinary skill in the art may still derive other drawings from these accompanying drawings without any creative effort.

FIG. 1 is a schematic diagram of labor supply-labor demand model measured in the real wage-unit according to the present invention.

FIG. 2 is a schematic diagram of aggregate supply-aggregate demand model.

FIG. 3 is a schematic diagram showing the relationship between AS-AD model and NS-ND model.

FIG. 4 is a schematic diagram of 4D model of supply and demand.

FIG. 5 is a schematic diagram of N^{w}-Y^{d} model of supply-demand equilibrium.

FIG. 6 is a schematic diagram showing movement of aggregate demand curve and labor demand curve and extension of supply-demand equilibrium curve.

FIG. 7 is a schematic diagram of the 4D model and full employment curve.

FIG. 8 is a schematic diagram showing different extension directions of supply-demand equilibrium curve and changes in employment gap.

FIG. 9 is a N^{w}-Y^{d} model of annual supply-demand equilibrium of the United States from 1946 to 2013.

FIG. 10 is a schematic diagram showing the relationship among labor force, full employment, and employment of the United States from 1946 to 2013.

FIG. 11 is a schematic diagram of the wage-income ratio of the United States from 1946 to 2013.

FIG. 12 is a schematic diagram of an employment gap of the United States from 1946 to 2013.

FIG. 13 is a schematic diagram of an output gap of the United States from 1946 to 2013.

FIG. 14 is a schematic diagram of a quarterly supply-demand equilibrium curve of the United States from 2005 to 2014.

FIG. 15 is a schematic diagram of a system of a graphical method for aggregate economic analysis.

FIG. 16 is a flow chart of a processing device of the present invention.

### DETAILED DESCRIPTION OF EMBODIMENTS

In order to make the objectives, technical solutions and advantages of the present invention clearer, the following clearly and completely describes the technical solutions in the embodiments of the present invention with reference to the accompanying drawings in the embodiments of the present invention.

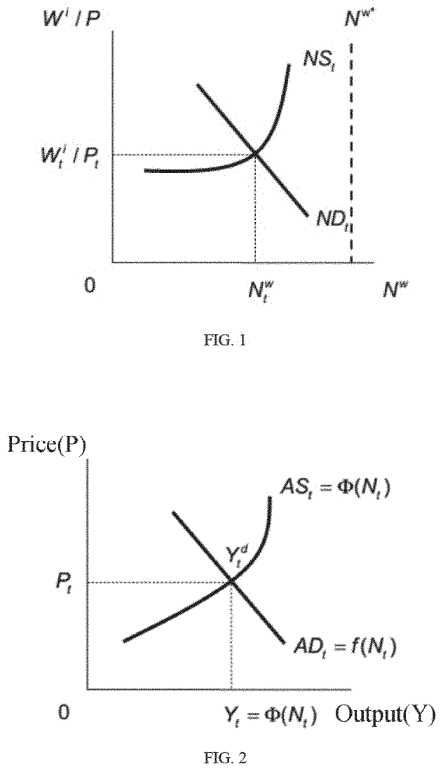

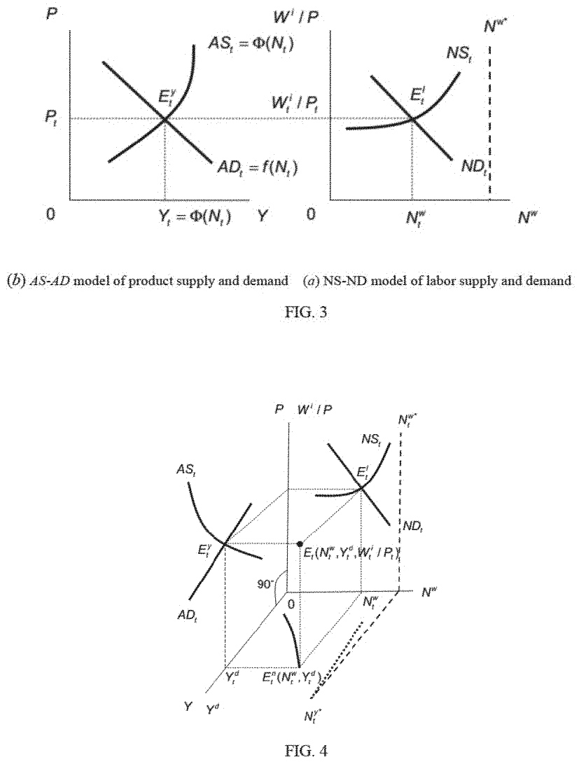

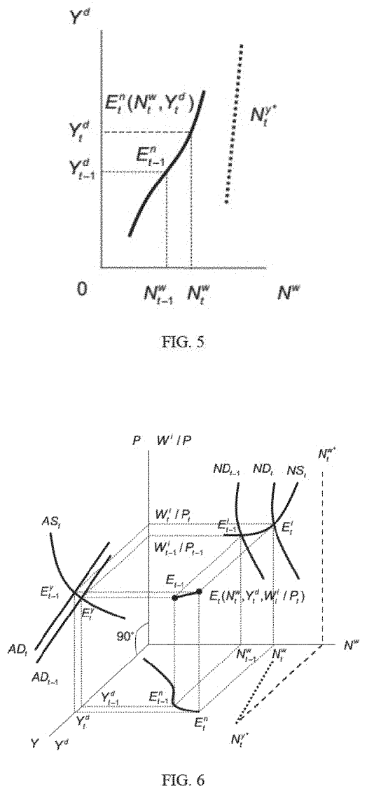

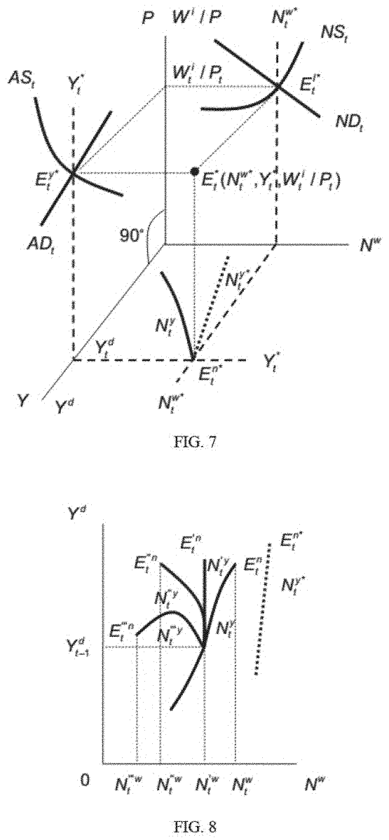

As shown in FIGS. 1-14, long-term and short-term statuses of the economy in the United States are scientifically interpreted by using a graphical method for aggregate economic analysis according to the present invention.

Construction of Assumptions of a N^{w}-Y^{d} Model of Supply-Demand Equilibrium

1) Employment and full employment measured in the real wage-unit are used. The employment measured in the real wage-unit: Nₜ^{w}=Nₜ·W̅ₜ(1). The full employment measured in the real wage-unit: Nₜ^{w*}=vₜWₜNₜ^{*} (7).

2) A calculation method for a rising coefficient of wages is determined. The establishment of a N^{w}-Y^{d} model of supply-demand equilibrium needs to interpret the assumptions of a full employment curve, and on the premise, a full employment curve that reflects a long-term trend is drawn. Equation (7) relates to an estimate of real average wage of full employment, which requires an estimate of a rising coefficient of the real average wage relative to the real value when the economy achieves full employment. The wage level in an optimal state is estimated according to the real wage, and the real average wage adjusted by the rising coefficient is used to calculate the full employment measured in the real wage-unit. The coefficient depends on the level of full employment per year relative to real employment.

3) A basis for the full employment and a calculation method for potential output are determined. According to the usual practice, if there is a 5% unemployment rate in the labor force of an economy, it may be regarded as full employment, and 95% of the employment corresponding to the labor force of an economy per year may be calculated as full employment. According to the level of full employment per year, the potential output corresponding to the full employment may be estimated: Yₜ^{p}(1/gₜ^{*}) ΔNₜ^{w*} (8). The sum of the real employment Nₜ^{w} and the unemployment Nₜ^{*} is equal to the full employment Nₜ^{w*}, i.e., Nₜ^{w}+Nₜ^{*}=Nₜ^{w*} (16).

4) A basis for an optimal wage-income ratio is selected. In the state of full employment, the current wage-income ratio needs to be adjusted for obtaining an optimal wage-income ratio of an economy, and the magnitude of adjustment also depends on the level of real employment relative to full employment. Thus, in a given period, the potential output depends on the full employment measured in the real wage-unit and ultimately depends on the level of full employment relative to real employment.

Construction of a N^{w}-Y^{d} Model of Annual Supply-Demand Equilibrium of the United States

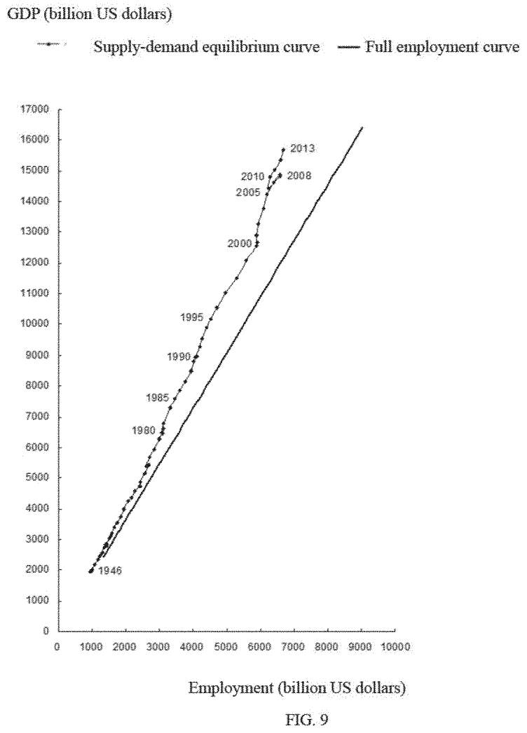

A N^{w}-Y^{d} model of annual supply-demand equilibrium of the United States from 1946 to 2013 is constructed by estimating full employment and potential output according to the empirical data of employment and real GDP in the United States, as shown in FIG. 9. The data came from the Department of Commerce and the Department of Labor in the United States.

The horizontal axis of the model is employment measured in the real wage-unit, and the vertical axis of the model is real gross output (real effective demand). The figure shows a continuous supply-demand equilibrium curve and a continuous full employment curve. The continuous supply-demand equilibrium curve reflects real supply-demand equilibrium state of the United States from 1946 to 2013, and the continuous full employment curve reflects an “optimal” supply-demand equilibrium state in the United States during the period. The model reflects the long-term state of economy of the United States, and outlines employment and gross output of the United States after the war, and the corresponding full employment and potential output.

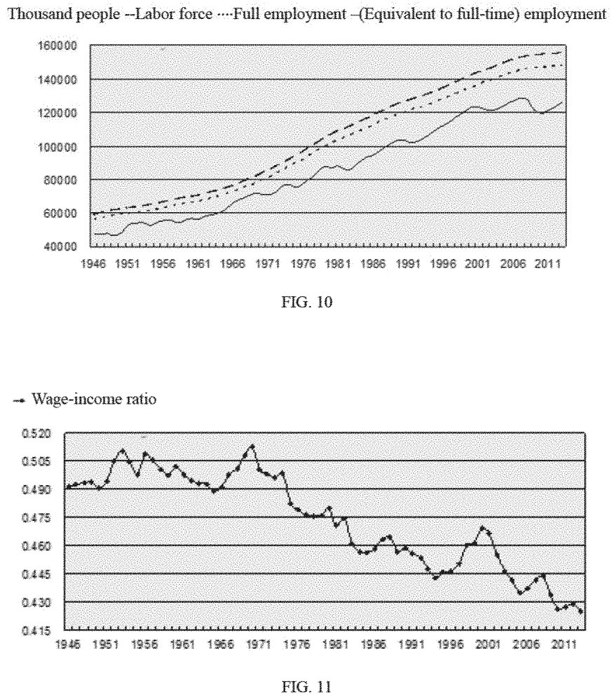

Brief Description on the N^{w}-Y^{d} Model of Annual Supply-Demand Equilibrium of the United States
1) The full employment in the model is related to the population of the United States. First, the labor force of an economy is linked to the total population, and the labor force should be proportional to the total population. Second, the full employment of an economy is linked to the labor force, and the full employment should be proportional to the labor force. It can be seen by observing the changes in labor force, full employment, and real employment of the United States from 1946 to 2013 (as shown in FIG. 10) that the full employment shows the same growth trend as the labor force. Since the labor force is proportional to the total population, the full employment is proportional to the total population.

2) The model reflects the relationship between real employment and full employment in the United States in different periods. The N^{w}-Y^{d} model of annual supply-demand equilibrium of the United States is established on the basis of the relationship between real employment and full employment. As shown in FIG. 10, in general, the real employment in the United States is lower than its full employment level for a long term. Although they show the same trend, the real employment fluctuates much more sharply, shows obvious periodic changes, and even decreases in some years. To understand the long-term status of employment in the United States, it can be achieved by observing the changes in real employment relative to full employment.

3) The model reflects the relationship between real gross output (depending on effective demand) and potential output of the United States in different periods. In the N^{w}-Y^{d} model of annual supply-demand equilibrium of the United States, the real employment and the full employment are based on the number of labor force, and the model reflects the relationship between real employment (depending on labor demand) and effective demand and the relationship between full employment (depending on labor supply) and potential output. On the basis, the relationship between real gross output (depending on effective demand) and potential output of the United States in different periods is described in order to visually investigate the two relationships.

Slopes of Supply-Demand Equilibrium Curve and Full Employment Curve of the United States

In general, from 1946 to 2013, the slope of supply-demand equilibrium curve of the United States is smaller than the slope of full employment curve. The slope of supply-demand equilibrium curve of the United States is 0.43, and the slope of full employment curve of the United States is 0.55 (the optimal wage-income ratio is assumed to be 0.55). This means that, on average, only 43 US dollars of annual real income 100 US dollars is used to pay wages. In the state of full employment, 55 US dollars of annual income 100 US dollars is required for paying wages. Due to the continuous increase in total population and labor force, the labor demand of the United States is smaller than the increase rate of labor supply. Thus, the gap between the real employment and the full employment has been expanding for a long term. It should be noted that in different periods, the trends of changes in the slope of the supply-demand equilibrium curve and the slope of the full employment curve of the United States are greatly different. According to the N^{w}-Y^{d} model of annual supply-demand equilibrium of the United States, the following periods are divided:

First period: from 1946 to 1969, the supply-demand equilibrium curve tilts to the upper right, and the slope of the supply-demand equilibrium curve of the United States is slightly smaller than the slope of the full employment curve. During the period, the slope of the supply-demand equilibrium curve of the United States is 0.50, which is close to the optimal level of 0.55. Generally speaking, the employment rate increases in the period, from 83.8% in 1946 to 92.4% in 1969. At the same time, the wage-income ratio remains stable for a long term, indicating that the overall situation of employment and wages is good.

Second period: from 1969 to 1983, although the supply-demand equilibrium curve tilts to the upper right, the slope of the supply-demand equilibrium curve of the United States is much smaller than the slope of the full employment curve. The slope of the supply-demand equilibrium curve during the period is 0.38. The employment rate during the period decreases from 92.4% to 80.7%, and the wage-income ratio also tends to decrease. Hence, the employment rate and the wage situation in the United States have deteriorated severely during the period.

Third period: from 1983 to 2000, the supply-demand equilibrium curve tilts to the upper right, and the slope of the supply-demand equilibrium curve is improved relative to the previous period. During the period, the slope of the supply-demand equilibrium curve of the United States is 0.46, the employment and wages in the United States perform well, the employment rate rises from 80.7% to 91.0%, and the wage-income ratio is gradually stable and begins to rise rapidly from 1995.

Fourth period: from 2000 to 2010, the tilting amplitude of the supply-demand equilibrium curve to the upper right shrinks dramatically, and the supply-demand equilibrium curve of the United States gradually deviates from the long-term change trend of the full employment curve. The slope of the supply-demand equilibrium curve of the United States during the period is only 0.31. The employment rate falls from 91.0% to 81.4%, and the wage-income ratio tends to decrease again.

Fifth period: from 2010 to 2013, the tilting amplitude of the supply-demand equilibrium curve to the right begins to recover. During the period, the slope of the supply-demand equilibrium curve of the United States is 0.42, and is still significantly lower than the level of full employment. The employment rate rises from 81.4% to 85.0%, with a slight rebound, but the wage-income ratio is not improved and reaches an all-time low of 0.42 in 2013, indicating that the economy of the United States still has a fundamental distribution problem on the whole.

By observing the relationship between the supply-demand equilibrium curve of the United States and the full employment curve, there are several points worthy of further discussion. 1) The general situation of the economy of the United States is a certain distance between the supply-demand equilibrium curve and the full employment curve, indicating that the effective demand is lower than the potential output of the United States for a long term. 2) The supply-demand equilibrium curve of the United States is far from the full employment curve, indicating that the United States has a high unemployment rate for a long term; it turns out that the economy of the United States has been operating at a level below full employment for a long term. 3) The employment of the United States during the period of low employment and the growing path of effective demand cause the risks of persistent unemployment and economic crisis.

Long-Term Changes in Employment, Gross Output, and Wage-Income Ratio

The N^{w}-Y^{d} model of annual supply-demand equilibrium of the United States reflects long-term changes in real employment of the economy relative to full employment, and also reflects long-term changes in real income distribution of the economy relative to optimal income distribution.

FIG. 11 shows long-term changes in wage-income ratio of the United States from 1946 to 2013. Assuming that the optimal wage-income ratio of the United States is 0.55, it can be seen that the wage-income ratio of the United States is significantly lower than the optimal level for a long term. When the gap between the two expands, it indicates that the income distribution is not conducive to the employment and consumption of workers, and the economy tends to deteriorate.

Changes in wage-income ratio of the United States are roughly divided into the following four stages:

1) From 1946 to 1970, the wage-income ratio of the United States fluctuated in the range of 0.491-0.513. During the period, the wage-income ratio of the United States was relatively high and relatively stable.

2) From 1970 to 1994, the wage-income ratio of the United States continued to decrease. In 1971, the wage-income ratio was 0.513. The ratio has decreased significantly since 1971. The growth rate of gross wages of the United States has gradually lagged behind the growth of the overall economy. In 1994, the wage-income ratio fell to 0.443.

3) From 1994 to 2000, the wage-income ratio of the United States rebounded slightly. The wage-income ratio has been recovered from 0.443 since 1995, and recovered to 0.469 in 2000.

4) From 2000 to 2013, the wage-income ratio of the United States decreased again rapidly. The indicator has decreased since 2001 and reached its historical low of 0.425 in 2011, indicating that only 40% of the total annual social income is used to pay for labor. Hence, the income distribution system of the United States has long been adverse to workers, and is the basic reason for limiting the increase in employment and wage levels of the economy.

The slope of the supply-demand equilibrium curve indicates that the long-term disequilibrium between the gross wage and gross income of the United States is the root cause of long-term low employment rate in the economy.

Interpret Short-Term Economic Status of the United States Using Changes in Employment Gap and Output Gap

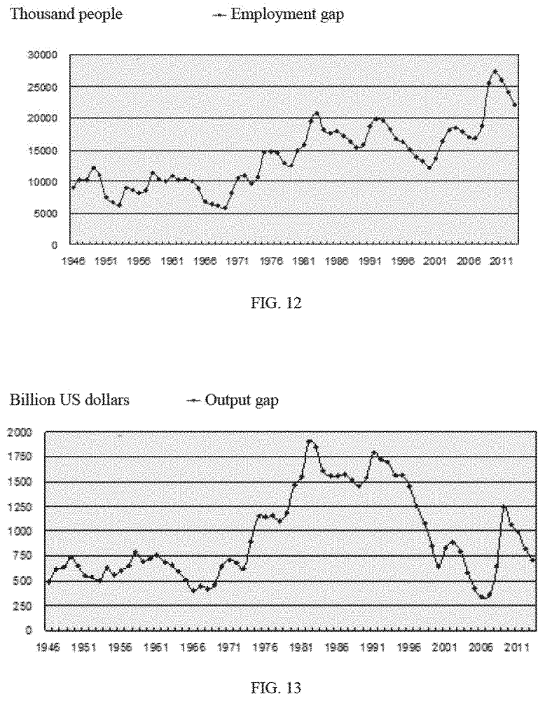

FIG. 12 shows that the United States has had certain employment gap after the war. Since the end of the 1960s, the employment gap has begun to expand and has remained at more than 10 million people for a long term. In 1983, the employment gap quickly broke through 20 million people. Hence, the United States experienced a serious unemployment crisis from the early 1970s to the mid-1980s. The employment gap of the United States has expanded rapidly again since 2001. Despite several years of adjustment, the employment gap increased dramatically in 2007, and quickly broke through the highest post-war level in 2009, surpassing 25 million people. Despite various policy measures taken by the US government, the employment gap of the United States still had 22.18 million people by the end of 2013. In fact, the employment gap of the United States has exceeded 20 million people for five continuous years, which indicates that at least until the end of 2013, the United States has not yet emerged from the most severe unemployment crisis after the war.

As shown in FIG. 13, before the early 1970s, the output gap of the United States remained within 730 billion US dollars for a long term. After that, the output gap showed a cyclical expansion trend and reached an all-time high of 1,908 billion US dollars in 1982. It was not until the early 1990s that the output gap of the United States began to shrink significantly and reached a minimum of 336.7 billion US dollars in post-war history in 2006. After the unemployment crisis broke out in the United States in September 2007, the output gap increased sharply, and quickly broke through 1 trillion US dollars in 2009. In the next four years, the output gap shrunk as a result of various economic stimulus measures. By 2013, the output gap has recovered to a relatively low level of 70 million US dollars.

Relationship Between Employment Gap and Output Gap of the United States

It is worth noting that since the change in output gap depends first on the change in employment gap, the change in output gap cannot be investigated by departing from the change in employment gap. Different conclusions about the output gap may be obtained by analyzing macroeconomic data of the United States with different analysis methods. The output gap described by the macroeconomics according to the idea that “the output fluctuates around the trend level” is substantially different from the output gap described by the N^{w}-Y^{d} model of supply-demand equilibrium in that the output fluctuates at a level lower than the potential output. If economists rely on the foregoing output gap to investigate changes in economy of the United States, it is likely to make erroneous conclusions.

On the other hand, although the output gap depends to a large extent on the employment gap, the changes of the both are not completely identical. In a notable example, the employment gap of the United States has continued to expand since the beginning of this century; until 2008 after the economic crisis broke out, the output gap showed a significant expansion. The employment gap of the United States in 2013 was still higher than the pre-crisis level, and the output gap has recovered to a relatively low level. Hence, the starting time, expected trend and severity of the crisis reflected by the employment gap indicator cannot be approximately judged by the output gap. This shows that if we rely only on the output gap to analyze the unemployment crisis of the United States, it is easy to draw a wrong conclusion.

Construction of a N^{w}-Y^{d} Model of Quarterly Supply-Demand Equilibrium of the United States from 2005 to 2014

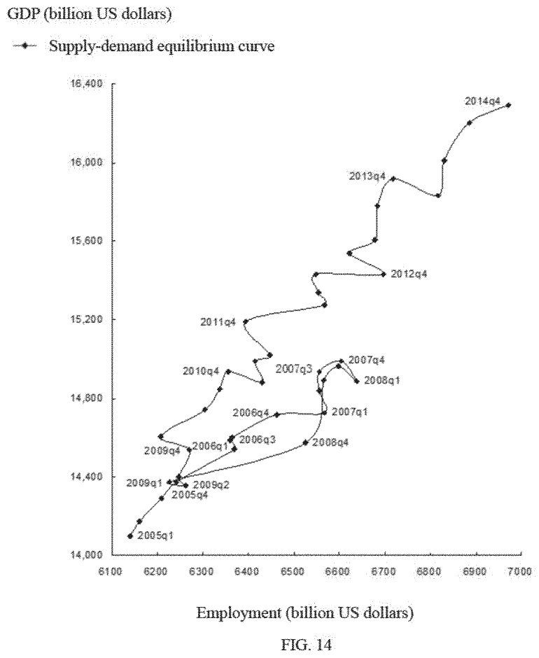

A N^{w}-Y^{d} model of quarterly supply-demand equilibrium of the United States is constructed using the quarterly data of employment and real GDP of the United States from 2005 to 2014. The model provides an empirical evidence of a changing path of employment of the United States relative to effective demand in the case of sustained unemployment. The N^{w}-Y^{d} model of quarterly supply-demand equilibrium of the United States can be used to more clearly observe the short-term evolution of the unemployment crisis in 2007, as shown in FIG. 14.

Interpretation of Economic Crisis of the United States Since 2007 by Using the N^{w}-Y^{d} Model of Quarterly Supply-Demand Equilibrium

The extension direction and magnitude of the quarterly supply-demand equilibrium curve of the United States reflect the starting point and development process of the unemployment crisis of the United States in 2007. The development process may be roughly divided into the following five phases:

First phase: from the first quarter of 2006 to the first quarter of 2007: employment growth and employment stagnation of the United States alternately changed. The basic characteristic of the N^{w}-Y^{d} model of supply-demand equilibrium in the phase was: the supply-demand equilibrium curve extended to the upper right. The increase in employment (measured in the real wage-unit) stagnated in the second and third quarters of 2006, followed by two quarters of employment growth recovery. At the same time, the GDP indicator (effective demand) was obviously weak from the third quarter of 2006.

Second phase: from the first quarter of 2007 to the second quarter of 2008: the employment and the effective demand alternately stagnated. The basic characteristic of the N^{w}-Y^{d} model of supply-demand equilibrium in the phase was: the supply-demand equilibrium curve extended to the upper left. The employment fell in the second and third quarters of 2007, indicating that the United States has fallen into the unemployment crisis. The employment was then recovered for two quarters, followed by a significant decrease in the second quarter of 2008. At the same time, the real GDP indicator was also obviously weak in the fourth quarter of 2007, and the real GDP fell sharply in the first quarter of 2008.

Third phase: from the second quarter of 2008 to the first quarter of 2009: the employment and the effective demand decreased greatly. The basic characteristic of the N^{w}-Y^{d} model of supply-demand equilibrium in the phase was: the supply-demand equilibrium curve extended to the lower left. In the third quarter of 2008, the employment of the United States further deteriorated. As a result, the supply-demand equilibrium curve greatly extended to the lower left in three consecutive quarters, and the economy of the United States experienced a double decrease in employment and output, indicating that the economic crisis has fully erupted. This is the worst case in the process of economic development.

Fourth phase: from the first quarter of 2009 to the first quarter of 2010: employment stagnation accompanied by an increase in effective demand. The basic characteristic of the N^{w}-Y^{d} model of supply-demand equilibrium in the phase was: the supply-demand equilibrium curve extended upward. The United States was gradually getting rid of the trend of declining employment, and the employment indicator was generally stagnant. From the third quarter of 2009, the GDP began to resume growth, but the employment indicator has not improved significantly; even in the first quarter of 2010, the employment indicator fell to the lowest point of the crisis process.

Fifth phase: from the first quarter of 2010 to the fourth quarter of 2014: the growth, stagnation and decrease of the employment of the United States alternated. The basic characteristic of the N^{w}-Y^{d} model of supply-demand equilibrium in the phase was: the supply-demand equilibrium curve extended to the upper right tortuously. The employment of the United States has improved since the second quarter of 2010, and the economy in the following years was very unstable. As of the end of 2014, although the supply-demand equilibrium curve did not extend to the lower left again, five quarters of employment fell from the previous quarter. At the same time, the output growth was obviously negative twice. In the second quarter of 2013, the employment indicator recovered to the pre-crisis level. This locus of tortuous extension to the upper right showed that, on the whole, the economy of the United States has not completely shaken off the threat of the unemployment crisis.

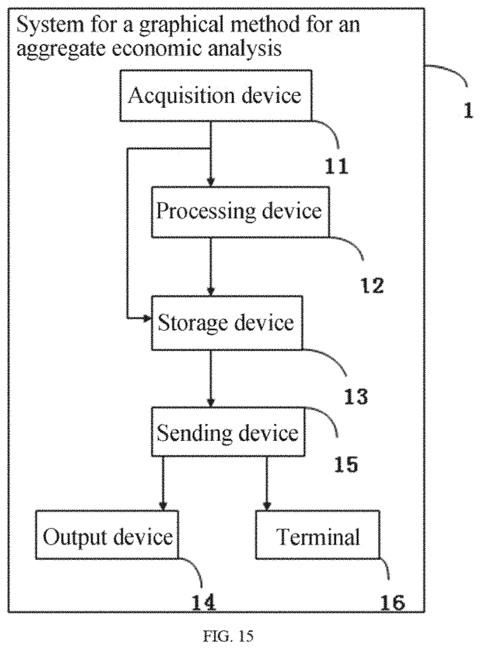

As shown in FIG. 15, the present invention further provides a system for the graphical method for the aggregate economic analysis, comprising:

an acquisition device 11, which is configured to obtain annual and quarterly raw macroeconomic data of a country or region which comprises data of GDP, employment, price index, wage, and population, and comprising a server provided by a data service provider, a database connection tool, an external storage device or a manual input device; and

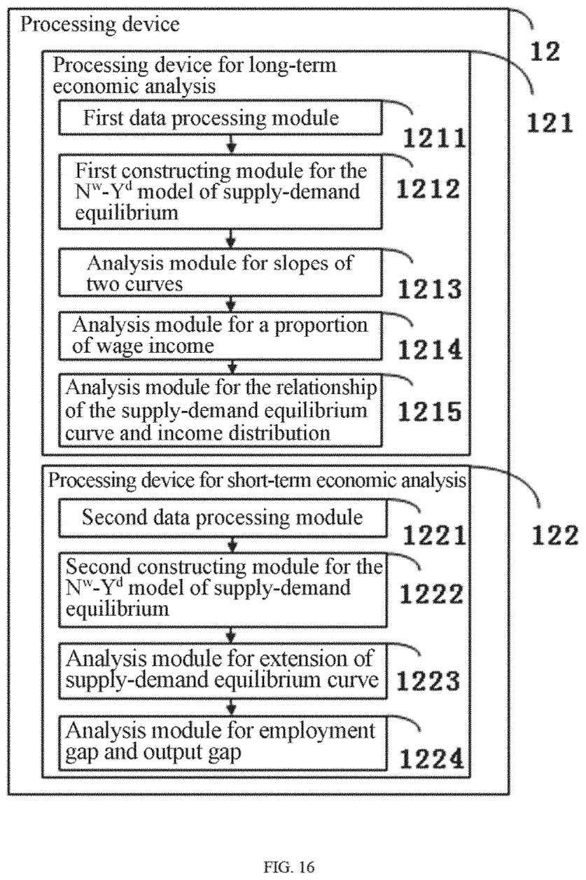

a processing device 12 (shown in FIG. 16) configured for long-term and short-term economic analyses, and comprising at least one central processing unit (CPU) or specific processor.

The processing device 121 for the long-term economic analysis comprises:

a first data processing module 1211, which is configured to establish macroeconomic time series of a N^{w}-Y^{d} model of annual supply-demand equilibrium based on the annual raw macroeconomic data acquired by the acquisition device;

a first constructing module 1212 for the N^{w}-Y^{d} model of supply-demand equilibrium, which is configured to construct the N^{w}-Y^{d} model of annual supply-demand equilibrium based on the macroeconomic time series of a N^{w}-Y^{d} model of annual supply-demand equilibrium;

an analyzing module 1213 for slopes of two curves, which is configured to respectively calculate a slope of a supply-demand equilibrium curve and a slope of a full employment curve at an overall period and different periods based on the N^{w}-Y^{d} model of annual supply-demand equilibrium, and to respectively compare the slopes of the supply-demand equilibrium curve at an overall period and different periods and the slope of a full employment curve;

an analysis module 1214 for a proportion of a wage income, which is configured to respectively calculate proportions of the wage income at the overall period and different period based on the N^{w}-Y^{d} model of annual supply-demand equilibrium, and to analyze long-term changes of the proportion of the wage income; and

an analysis module 1215 for a relationship of the supply-demand equilibrium curve and an income distribution, which is configured to analyze a relationship between the slope of the supply-demand equilibrium curve and the changes of the proportion of the wage income to analyze a long-term state of the economy.

The processing device 122 for the short-term economic analysis comprises:

a second data processing module 1221, which is configured to establish macroeconomic time series of a N^{w}-Y^{d} model of quarterly supply-demand equilibrium in a country or region at a period based on the quarterly raw macroeconomic data acquired by the acquisition device;

a second constructing module 1222 for the N^{w}-Y^{d} model of supply-demand equilibrium, which is configured to construct the N^{w}-Y^{d} model of quarterly supply-demand equilibrium based on the macroeconomic time series of the N^{w}-Y^{d} model of quarterly supply-demand equilibrium;

an analysis module 1223 for an extension of the supply-demand equilibrium curve, which is configured to analyze a direction and amplitude of the extension of the supply-demand equilibrium curve in different stages based on the N^{w}-Y^{d} model of the quarterly supply-demand equilibrium; and

an analysis module 1224 for an employment gap and an output gap, which is configured to obtain time series of the employment gap and the output gap based on the N^{w}-Y^{d} model of annual or quarterly supply-demand equilibrium, and to explain a short-term state of the economy based on changes and relationship of the changed of the employment gap and the output gap.

Government departments, institutions or enterprises may separately implement the above-described embodiments according to different needs, or may select all or part of the long-term economic analysis system or the short-term economic analysis system separately, or combine these embodiments in different implementation manners.

In some embodiments, the system further comprises a storage device 13 configured to store the raw macroeconomic data, the N^{w}-Y^{d} model of supply-demand equilibrium and analyzed results of respective analysis modules. The storage device may comprise one or more readable storage media, such as a floppy disk of a computer, a USB flash disk, a removable hard disk, a Read-Only Memory (ROM), a Random Access Memory (RAM), a disk or a CD. Still further, the central processor can be configured to communicate with a storage medium to perform a series of instruction operations on the storage medium on the system.

In some embodiments, the system further comprises an output device 14 configured to output the N^{w}-Y^{d} model of supply-demand equilibrium and analyzed results of respective analysis modules, and specifically, the output device is a display or a print device.

In some embodiments, the system further comprises a sending device 15 configured to send the N^{w}-Y^{d} model of supply-demand equilibrium and analyzed results of respective analysis modules to a terminal 16. Specifically, the sending device is a Bluetooth unit or a WIFI wireless network transmission unit or a wired network transmission unit or 2.5G, 3G, 40, and 5G transmission units.

The system may further comprise at least one wired or wireless network interface, at least one input and output interface and at least one operating system, such as Windows Server™, Mac OS X™, Unix™, Linux™ and FreeBSD™.

Through the description of the above embodiments, those skilled in the art can clearly understand that the present invention can be implemented by means of software and necessary general hardware, and of course, dedicated hardware, dedicated CPU, dedicated memory, specific components may be adopted to achieved to implement the present invention. In general, functions performed by computer programs can be easily implemented with the corresponding hardware, and the specific hardware structure used to implement the same function can be various, such as analog circuits, digital circuits, or dedicated circuits, etc. However, for the present invention, software program implementation is a better implementation in more cases. Based on this, the technical solution of the present invention, which is essential or contributes to the prior art, can be embodied in the form of a software product stored in a readable storage medium, such as a floppy disk of a computer, a USB flash disk, a removable hard disk, a Read-Only Memory (ROM), a Random Access Memory (RAM), a disk or a CD, etc., including instructions to make a computer device (a personal computer, a server, or a network device, etc.) performs the method described in the embodiments of the present invention.

The method provided by the invention establishes a graphical analysis method for unifying the labor supply and demand model and the product supply and demand model through the four-dimensional model of supply and demand. For a long time, the macroeconomic analysis separates the product market from the labor market, and cannot establish a relationship between them. The method of the present invention effectively solves this problem. Through the model of supply and demand equilibrium, a continuous supply and demand equilibrium curve and a continuous full employment curve are drawn in different periods, reflecting the actual relationship and optimal relationship between employment and GDP in this period. The above relationship can be described by a specific function expression, thereby organically linking the employment, GDP, and income distribution of a country's main economic aggregate indicators. The model of supply and demand equilibrium is generally applicable to long-term and short-term economic analysis. The development of the long-term economic trend and the change of the economic cycle are analyzed by the change of the slope of the supply-demand equilibrium curve relative to the full employment curve. Through the extension of the supply-demand equilibrium curve, the change in the gap between the supply and demand equilibrium curve and the full employment curve is applied to analyze the change of the direction and amplitude of the country's short-term economy. Existing analytical methods artificially set different models for long-term and short-term, and lack clear boundary between long-term models and short-term models. It can be seen that the method and system provided by the present invention can systematically analyze the change of the relationship between the main macroeconomic indicators of each economy, and provide a policy basis for governments to provide timely protection and response to economic crisis. It can also provide effective technical support for economic analysis, economic forecasting and production decisions of various industries and organizations. It has been proved that the existing macroeconomic model cannot accurately predict the economic crisis, and cannot effectively respond after the crisis.

For the system disclosed in the embodiment, since it corresponds to the method disclosed in the embodiment, and the description is relatively simple, the relevant parts can be referred to the description of the method.

The foregoing descriptions are only preferred embodiments of the present invention, but the scope of the present invention is not limited thereto. Any skilled who is familiar in the art could make equivalent substitutions or modifications to the technical solutions of the present invention and the inventive concepts thereof within the technical scope of the present invention, and the substitutions or modifications shall fall within the protection scope of the present invention.

We claim:

1. A graphical method for aggregate economic analysis, comprising the following steps:
defining employment measured in a real wage-unit for an economy at time t:
Nₜ^{w}=Nₜ·W̅ₜ (1)
wherein the equation shows that at each time point t, the employment measured in the real wage-unit is Nₜ^{w} which is equal to a product of the employment Nₜ and the real average wage W̅ₜ at the time point, and is a real gross wage of the economy;
constructing a labor supply-labor demand model (NS-ND model) measured in the real wage-unit for the economy based on a Keynes's labor supply and labor demand model according to basic measurement units, labor units, monetary units and time units selected by Keynes; wherein a vertical axis of the model is a real wage index Wⁱ/P; Wₜⁱ represents a nominal wage index, and a horizontal axis is employment N^{w} measured in the real wage-unit; two intersected lines within a coordinate are respectively a labor supply curve NSₜ and a labor demand curve NDₜ, and an intersection of the curve NSₜ and the curve NDₜ determines an equilibrium employment Nₜ^{w} and a real wage level Wₜⁱ/Pₜ;
establishing an aggregate supply-aggregate demand model (AS-AD model) according to Keynes's aggregate supply function and aggregate demand function; wherein a vertical axis is price P, and a horizontal axis is gross output Y; two intersected lines within a coordinate are respectively an aggregate supply curve ASₜ and an aggregate demand curve ADₜ, an intersection of the curve ASₜ and the curve ADₜ shows that the product market is in equilibrium; at the time, the gross output is Yₜ, and the price level is Pₜ, and a corresponding employment is Ni,
rotating the AS-AD model 180 degrees leftward about the vertical axis P to share a vertical axis with the NS-ND model to obtain a combined graph of the NS-ND model and the AS-AD model; in the combined graph, rotating the AS-AD model 90 degrees forward about the vertical axis P in a vertical direction to form a 3D space graph composed of three coordinate axes, that is, a 4D model of supply and demand, or a N^{w}-Y-W^{t}/P 4D model;
wherein an x coordinate of the 3D graph represents the employment N^{w} measured in the real wage-unit, a y coordinate represents the real gross output (or real gross income) Y, and a z coordinate represents a nominal wage/price (Wⁱ/P); a coordinate intersection Eₜ(Nₜ^{w}, Yₜ^{d}, Wₜⁱ/Pₜ) of the intersections Eₜ^{*l} and Eₜ^{y} of respective curves of the NS-ND model and the AS-AD model in the 3D space shows that, at time t, when the labor supply and demand and the product supply and demand are in equilibrium, the equilibrium employment measured in the real wage-unit, the real value of effective demand (gross output or gross income), the nominal wage index, and the price index are respectively Nₜ^{w}, Yₜ^{d}, Wₜⁱ and Pₜ, and the coordinate intersection reflects an overall situation of supply-demand equilibrium of the economy;
wherein projections of three coordinate planes of the 4D model respectively constitute the following three interrelated supply-demand models:
a labor supply and labor demand graph which is a N^{w}-Wⁱ/P plane of the 3D space graph, wherein the vertical axis is the real wage index Wⁱ/P, and the horizontal axis is the employment N^{w} measured in the real wage-unit; the labor supply curve NS and the labor demand curve ND are both measured in the real wage-unit;
a product supply and product demand graph which is a Y-P plane of the 3D space graph, wherein the vertical axis is the price P, and the horizontal axis is the real gross output Y;
and a N^{w}-Y^{d} model of supply-demand equilibrium which is a bottom plane of the 3D space model;
analyzing the N^{w}-Y^{d} model of supply-demand equilibrium, wherein the employment N^{w} measured in the real wage-unit is set as the horizontal axis of the model, and a real value of effective demand Y^{d} is set as the vertical axis; the N^{w}-Y^{d} model describes a relationship between the employment measured in the real wage-unit and the effective demand, and the optimal state of the economy, in supply-demand equilibrium at each time point;
wherein the N^{w}*-Y^{d} model of supply-demand equilibrium is composed of two continuous supply-demand equilibrium curves;
wherein the 4D model presents in the space a connecting line of points constituted by equilibrium employment and effective demand in different periods, and a projection of the line on the bottom plane of the 3D space graph is called a supply-demand equilibrium curve;
wherein the other continuous supply-demand equilibrium curve is a full employment curve, which is a projection of the full employment curve of the NS-ND model on the N^{w}-Y^{d} model;
performing a long-term economic analysis by analyzing a relationship between a slope of the supply-demand equilibrium curve and a slope of the full employment curve over a certain period of time:
wherein at n time periods, when the slopes of the supply-demand equilibrium curve and the full employment curve both are assumed to be more than or equal to zero, that is, Sₜⁿ≥0 and Sₜ^{n*}≥0, the slope of the supply-demand equilibrium curve relative to the slope of the full employment curve is observed;
if the slope of the supply-demand equilibrium curve is smaller than the slope of the full employment curve, i.e., when Sₜⁿ<Sₜ^{n*} and Nₜ^{w}<Nₜ^{w*}, an output gap also expands as an employment gap expands, indicating that an employment rate of the economy continues to decrease; wherein in the N^{w}-Y^{d} model, a basic characteristic of long-term unemployment lies in that the supply-demand equilibrium curve gradually deviates from a trend level of full employment; and as the employment gap expands, the employment rate continues to decrease, and the economy falls into great depression without an intervention;
if the slope of the supply-demand equilibrium curve is larger than or equal to the slope of the full employment curve, an economic operation of that period does not show a deterioration trend;
performing a short-term economic analysis at a certain time point by analyzing a change in the gap between the supply-demand equilibrium curve and the full employment curve due to an extension of the supply-demand equilibrium curve;
wherein a method for analyzing an “unemployment gap” using the N^{w}-Y^{d} model is as follows:
as an “involuntary” unemployment is equal to a difference between the full employment and the real employment at time t, defining the difference as the employment gap, i.e.,
Nₜ^{wu}=Nₜ^{w*}−Nₜ^{w} (17)
wherein Nₜ^{wu} represents the “involuntary” unemployment (employment gap); Nₜ^{w*} represents the full employment; and Nₜ^{w} represents the real employment;
wherein equation (17) indicates that the “involuntary” unemployment of the economy is equal to the gap between the real employment and the full employment; in the N^{w}-Y^{d} model of supply-demand equilibrium, the employment gap appears as a horizontal distance between the supply-demand equilibrium curve Nₜ^{y} and the full employment curve Nₜ^{y*}; from time t−n to time t, if the supply-demand equilibrium curve Nₜ^{y} tends to extend to the full employment curve Nₜ^{y*}, the employment gap gradually shrinks;
from equation (17), giving the change in the employment gap at time t by the following equation:
ΔNₜ^{wu}=ΔNₜ^{w*}−ΔNₜ^{w} (20)
wherein ΔNₜ^{wu} represents the change in employment gap (measured in the real wage-unit); ΔNₜ^{w*} represents the change in full employment; and ΔNₜ^{w} represents the change in employment; *ΔNₜ^{w*}=Nₜ^{w*}−Nₜ₋₁^{w*} (10), and ΔNₜ^{w}=Nₜ^{w}−Nₜ₋₁^{w} (5);
wherein in the N^{w}-Y^{d} model of supply-demand equilibrium, the short-term change in the real employment depends on a direction and amplitude of the extension of the supply-demand equilibrium curve relative to the full employment curve, i.e., the change in the real employment relative to the full employment;
wherein different extension directions and magnitudes of the supply-demand equilibrium curve lead to at least four possibilities for changes in the employment gap as follows: first, the supply-demand equilibrium curve Nₜ^{y} extends to the upper right; an increase in real employment is greater than an increase in full employment; the change ΔNₜ^{wu} in employment gap is negative, so the employment gap shrinks, and the output gap also shrinks; if such state continues, the supply-demand equilibrium curve and the full employment curve ΔNₜ^{y*} intersect at a point for a long term, and the economy achieves a full employment equilibrium;
the extension of the supply-demand equilibrium curve Nₜ^{y} to the upper right is divided into three cases; according to a degree of the slope of the supply-demand equilibrium curve, the increase in real employment is possibly smaller than or equal to the increase in full employment; at the time, the change in employment gap is ΔNₜ^{wu} which is greater than or equal to 0;
second, the supply-demand equilibrium curve N*^{y}ₜ extends vertically upwards, and the full employment increases while the real employment does not change, so the change ΔNwu t in employment gap is positive; the employment gap expands, and the output gap possibly expand,
third, the supply-demand equilibrium curve N*^{y}ₜ extends to the upper left, and the full employment increases but the real employment decreases, so the change ΔNₜ^{wu} in employment gap is positive; the employment gap expands, and the output gap possibly expand;
fourth, the supply-demand equilibrium curve N*′″^{y}ₜ extends to the lower left; the full employment increases but the real employment and the output decrease simultaneously;
the change ΔNₜ^{wu} in employment gap is positive, and the employment gap and the output gap expand simultaneously; the decrease in effective demand causes the unemployment rate to rise, leading to an alternate decrease in wages and price levels.

2. The graphical method of claim 1, wherein the relationship between the equilibrium employment and the effective demand is reflected in the N^{w}-Y^{d} model:
due to Eₜ=Nₜ·W̅ₜ=Nₜ^{w}(1) and Yₜ^{d}=Yₜ, the relationship between the equilibrium employment and the effective demand is obtained from gₜ=Eₜ/Yₜ(2):
Yₜ^{d}=(1/gₜ)Nₜ^{w} (3)
wherein Yₜ^{d} represents the effective demand; gₜ represents the wage-income ratio; and Nₜ^{w} represents the equilibrium employment (measured in the real wage-unit), assuming that gₜ is a constant in the short term;
under an assumption that the wage-income ratio gₜ is a constant, the equilibrium employment is proportional to the effective demand; in the real economy, the equilibrium employment is generally positively correlated to the effective demand.

3. The graphical method of claim 1, wherein the supply-demand equilibrium curve has three basic characteristics, comprising a position, extension and slope of the supply-demand equilibrium curve;
position of the supply-demand equilibrium curve
for the economy, the position of the supply-demand equilibrium curve in the 3D space is uniquely determined, at time t, the equilibrium employment Nₜ^{w} and the corresponding effective demand Yₜ^{d} constitute an equilibrium point Eₜⁿ(Nₜ^{w}, Yₜ^{d}); the coordinates of the equilibrium point Eₜⁿ are used to express the position of the supply-demand equilibrium curve Nₜ^{y}; and the position of the supply-demand equilibrium curve moves from point Eₜ₋₁ⁿ, to point Eₜ^{N} from time t−1 to time t;
slope of the supply-demand equilibrium curve
from time t−1 to time t, the effective demand increases from Yᵢ₋ₙ^{d} to Yₜ^{d}, while the employment increases from N_{t-N}^{w} to Nₜ^{w}, and the supply-demand equilibrium point moves from Eᵢ₋ₙⁿ to Eₜⁿ; the slope of the supply-demand equilibrium curve is defined as a ratio of the change in employment to the change in effective demand during the period;
Sₜⁿ=(Nₜ^{w}−N_{t-N}^{w})/(Yₜ^{d}−Yₜ₋ₙ^{d}) (4)
wherein Sₜⁿ represents the slope of the supply-demand equilibrium curve from t−n to t; Nₜ^{w} and Nₜ₋ₙ^{w} respectively represent the equilibrium employment at time t and time t−n; and Yₜ^{d} and Yₜ₋ₙ^{d} respectively represent effective demands at time t and time t−n;
in a certain period, the slope of the supply-demand equilibrium curve reflects a growth rate of the employment measured in the real wage-unit relative to the effective demand, and is used to describe long-term changes in the employment; under the condition of increasing effective demand, the slope Sₜⁿ of the supply-demand equilibrium curve exists in three cases:
when Sₜⁿ>0, the supply-demand equilibrium curve tilts to the right, which means that during the period, when the effective demand increases, the employment also increases;
if Sₜⁿ is smaller than a previous slope, the employment measured in the real wage-unit increases slowly relative to the increase in the effective demand;
if Sₜⁿ is larger than the previous slope, the employment and the real average wage increase fast relative to the effective demand;
when Sₜⁿ=0, the supply-demand equilibrium curve is vertical, which means that when the effective demand increases, the employment and the real average wage remain unchanged for a long term;
when Sₜⁿ<0, the supply-demand equilibrium curve tilts to the left, which means that when the effective demand increases, the employment decreases; the larger the absolute value of Sₜⁿ is, the greater the decrease in employment and real average wage relative to the increase in effective demand is;
extension of the supply-demand equilibrium curve
the extension of the supply-demand equilibrium curve is described by two indicators which are the change in employment ΔNₜ^{w} and the change in effective demand ΔYₜ^{d}:
ΔNₜ^{w}=Nₜ^{w}−Nₜ₋₁^{w} (5)
ΔYₜ^{d}=Yₜ^{d}−Yₜ₋₁^{d} (6)
from time t−1 to time t, the change in employment determines the extension direction of the equilibrium curve under the assumption that the change in effective demand ΔYₜ^{d} is positive;
when ΔNₜ^{w}>0, the employment increases, and the supply-demand equilibrium curve extends to the upper right;
when ΔNₜ^{w}>0, the employment is unchanged, and the supply-demand equilibrium curve extends upwards; and
when ΔNₜ^{w}>0, the employment decreases, and the supply-demand equilibrium curve extends to the upper left.

4. The graphical method of claim 2, wherein the supply-demand equilibrium curve has three basic characteristics, comprising a position, extension and slope of the supply-demand equilibrium curve;
position of the supply-demand equilibrium curve
for the economy, the position of the supply-demand equilibrium curve in the 3D space is uniquely determined, at *time t, the equilibrium employment Nₜ^{w} and the corresponding effective demand Yₜ^{d} constitute an equilibrium point Eₜⁿ(Nₜ^{w}, Yₜ^{d}); the coordinates of the equilibrium point Eₜⁿ are used to express the position of the supply-demand equilibrium curve Nₜ^{y}; and the position of the supply-demand equilibrium curve moves from point Eₜ₋₁ⁿ to point Eₜⁿ from time t−1 to time t;
slope of the supply-demand equilibrium curve
from time t−1 to time t, the effective demand increases from Yₜ₋ₙ^{d} to Yₜ^{d}, while the employment increases from Nₜ₋ₙ^{w} to Nₜ^{w}, and the supply-demand equilibrium point moves from Eₜ₋ₙⁿ to Eₜ^{N}; the slope of the supply-demand equilibrium curve is defined as a ratio of the change in employment to the change in effective demand during the period;
Sₜⁿ=(Nₜ^{w}−Nₜ₋ₙ^{w})/(Yₜ^{d}−Yₜ₋ₙ^{d}) (4)
wherein Sₜⁿ represents the slope of the supply-demand equilibrium curve from t−n to t; Nₜ^{w} and Nₜ₋ₙ^{w} respectively represent the equilibrium employment at time t and time t−n; and Yₜ^{d} and Yₜ₋ₙ^{d} respectively represent effective demands at time t and time t−n;
in a certain period, the slope of the supply-demand equilibrium curve reflects a growth rate of the employment measured in the real wage-unit relative to the effective demand, and is used to describe long-term changes in the employment; under the condition of increasing effective demand, the slope Sₜⁿ of the supply-demand equilibrium curve exists in three cases:
when Sₜⁿ>0, the supply-demand equilibrium curve tilts to the right, which means that during the period, when the effective demand increases, the employment also increases;
if Sₜⁿ is smaller than a previous slope, the employment measured in the real wage-unit increases slowly relative to the increase in the effective demand;
if Sₜⁿ is larger than the previous slope, the employment and the real average wage increase fast relative to the effective demand;
when Sₜⁿ=0, the supply-demand equilibrium curve is vertical, which means that when the effective demand increases, the employment and the real average wage remain unchanged for a long term;
when Sₜⁿ<0, the supply-demand equilibrium curve tilts to the left, which means that when the effective demand increases, the employment decreases; the larger the absolute value of Sₜⁿ is, the greater the decrease in employment and real average wage relative to the increase in effective demand is;
extension of the supply-demand equilibrium curve
the extension of the supply-demand equilibrium curve is described by two indicators which are the change in employment ΔNₜ^{w} and the change in effective demand ΔYₜ^{d}:
ΔNₜ^{w}=Nₜ^{w}−Nₜ₋₁^{w} (5)
ΔYₜ^{d}=Yₜ^{d}−Yₜ₋₁^{d} (6)
from time t−1 to time 1, the change in employment determines the extension direction of the equilibrium curve under the assumption that the change in effective demand ΔYₜ^{d} is positive;
when ΔNₜ^{w}>0, the employment increases, and the supply-demand equilibrium curve extends to the upper right;
when ΔNₜ^{w}=0, the employment is unchanged, and the supply-demand equilibrium curve extends upwards; and
when ΔNₜ^{w}<0, the employment decreases, and the supply-demand equilibrium curve extends to the upper left.

5. The graphical method of claim 1, wherein the N^{w}−Y^{d} model further reflects a relationship between the full employment and a potential output;
at time t, if the full employment is not achieved, some assumptions about real wage are required for determining the full employment measured in the real wage-unit; if the real employment is not very different from the full employment, an assumption that the real average wage is unchanged before full employment is achieved is made; if the real employment is greatly different from the full employment, the real wage increases with the increase in employment, and a rising coefficient of real wage needs to be determined according to the slope of the labor supply curve;
Nₜ^{w*}=*vₜW̅ₜNₜ* (7)
wherein Nₜ^{w*} represents the full employment measured in the real wage-unit; *vₜ represents a real wage rising coefficient; W̅ₜ represents a real average wage; and Nₜ* represents the full employment;
in the case where the real wage rises as the employment increases, the potential output corresponding to the full employment is given by the following model:
Yₜ^{p}=(1/gₜ^{*})Nₜ^{w*} (8)
wherein Yₜ^{p} represents the potential output corresponding to the full employment; g* t represents the optimal wage-income ratio; and Nₜ^{w*} represents the full employment measured in the real wage-unit; equation (8) indicates that under the assumption that the “optimal” wage-income ratio g_{t*} is a constant, the potential output depends on the full employment, the real average wage and the rising coefficient of wages.

6. The graphical method of claim 1, wherein the full employment curve has three basic characteristics, comprising position, slope and extension of the full employment curve;
position of the full employment curve
in the N^{w}-Y^{d} model, the position of the full employment curve Nₜ^{y*} refers to the coordinates of point Eₜ^{n*} constituted by the full employment Nₜ^{w*} and the corresponding potential output Yₜ^{p}, and the values of the full employment Nₜ^{w*} and the corresponding potential output Yₜ^{p} determine the position of the full employment curve Nₜ^{y*}; as the values of the full employment and the potential output change over time, the position of the full employment curve accordingly changes;
slope of the full employment curve
from time t−n to time t, the full employment increases from Nₜ₋ₙ^{w*} to Nₜ^{w*}, so that the potential output increases from Yₜ₋ₙ^{p} to Yₜ^{p}, and the equilibrium point of the full employment moves from En* t−n to En* t; the slope of the full employment curve is defined as the ratio of the change in full employment to the change in potential output during the period;
Sₜ^{n*}=(Nₜ^{w*}−Nₜ₋ₙ^{w*})/(Yₜ^{p}−Yₜ₋ₙ^{p}) (9)
wherein Sₜ^{n*} represents the slope of the full employment curve from time t−n to time t; Nₜ^{w*} and Nₜ₋ₙ^{w*} respectively represent full employment at time t and time t−n; and Yₜ^{p} and Yₜ₋ₙ^{p} respectively represent potential outputs at time t and time t−n;
in a certain period, the slope of the full employment curve reflects the growth rate of labor supply relative to potential output, and is used to describe long-term changes in labor supply; under the condition of increasing potential output, the slope Sₜ^{n*} of the full employment curve exists in three cases:
when Sₜ^{n*}>0, the labor supply increases; if the value of Sₜ^{n*}is small, in the long term, the full employment measured in the real wage-unit increases slowly relative to the increase in the potential output;
when Sₜ^{n*}=0, the labor supply is unchanged, which means that in the long term, the full employment remains unchanged;
when Sₜ^{n*}<0, the labor supply decreases; the larger the negative value of Sₜ^{n*} is, the greater the decrease in long-term labor supply and real average wage relative to the increase in potential output is;
extension of the full employment curve
the extension of the full employment curve describes the change in full employment in the real wage-unit relative to the potential output over time, reflecting the short-term characteristics of the full employment curve;
the extension of the full employment curve is described by two indicators which are the change in full employment ΔNₜ^{w*} and the change in potential output ΔYₜ^{p};
ΔNₜ^{w*}=Nₜ^{w*}−Nₜ₋₁^{w*} (10)
wherein ΔNₜ^{w*} represents the change in full employment (measured in real wages) from time t−1 to time t; and Nₜ^{w*} and Nₜ₋₁^{w*} respectively represent full employment at time t and time t−1;
equation (10) shows that the change in full employment depends on short-term changes in full employment and real average wage; the change in full employment associated with the short-term change in labor force is not only closely related to the natural growth rate of a country's population, but also is closely related to the country's labor supply policy, involving a movement of a short-term labor supply curve;
ΔYₜ^{p}=Yₜ^{p}−Yₜ₋₁^{p} (11)
wherein ΔYₜ^{p} represents the change in potential output from time t−1 to time t; and Yₜ^{p} and Yₜ₋₁^{p} respectively represent potential output at time t and time t−1;
under the condition that the optimal wage-income ratio is set to be a constant, the change in potential output depends on the change in full employment; Yₜ^{p}=(1/gₜ^{*}) Nₜ^{w*} (8) is substituted into (11) to approximately obtain the following relationship:
ΔYₜ^{p}=(1/gₜ^{*})ΔNₜ^{w*} (12)
wherein ΔYₜ^{p} represents the change in potential output from time t−1 to time t; gₜ^{*} represents the optimal wage-income ratio; ΔNₜ^{w*} represents the change in full employment; and gₜ^{*} is assumed to be a constant.

7. The graphical method of claim 5, wherein the full employment curve has three basic characteristics, comprising position, slope and extension of the full employment curve;
position of the full employment curve
in the N^{w}-Y^{d} model, the position of the full employment curve Nₜ^{y*} refers to the coordinates of point Eₜ^{n*} constituted by the full employment Nₜ^{w*} and the corresponding potential output Yₜ^{p}, and the values of the full employment Nₜ^{w*} and the corresponding potential output Yₜ^{p} determine the position of the full employment curve Nₜ^{y*}; as the values of the full employment and the potential output change over time, the position of the full employment curve accordingly changes;
slope of the full employment curve
from time t−n to time t, the full employment increases from Nₜ₋ₙ^{w*} to Nₜ^{w*}, so that the potential output increases from Yₜ₋ₙ^{p}, to Yₜ^{p}, and the equilibrium point of the full employment moves from En* t−n to En* t, the slope of the full employment curve is defined as the ratio of the change in full employment to the change in potential output during the period;
Sₜ^{n*}=(Nₜ^{w*}−Nₜ₋ₙ^{w*})/(Yₜ^{p}−Yₜ₋ₙ^{p}) (9)
wherein Sₜ^{n*} represents the slope of the full employment curve from time t−n to time t; Nₜ^{w*} and Nₜ₋ₙ^{w*} respectively represent full employment at time t and time t−n; and Yₜ^{p} and Yₜ₋ₙ^{p} respectively represent potential outputs at time t and time t−n;
in a certain period, the slope of the full employment curve reflects the growth rate of labor supply relative to potential output, and is used to describe long-term changes in labor supply; under the condition of increasing potential output, the slope Sₜ^{n*} of the full employment curve exists in three cases:
when Sₜ^{n*}>0, the labor supply increases; if the value of Sₜ^{n*} is small, in the long term, the full employment measured in the real wage-unit increases slowly relative to the increase in the potential output;
when Sₜ^{n*}=0, the labor supply is unchanged, which means that in the long term, the full employment remains unchanged;
when Sₜ^{n*}<0, the labor supply decreases; the larger the negative value of Sₜ^{n*} is, the greater the decrease in long-term labor supply and real average wage relative to the increase in potential output is;
extension of the full employment curve
the extension of the full employment curve describes the change in full employment in the real wage-unit relative to the potential output over time, reflecting the short-term characteristics of the full employment curve;
the extension of the full employment curve is described by two indicators which are the change in full employment ΔNₜ^{w*} and the change in potential output ΔYₜ^{p};
ΔNₜ^{w*}=Nₜ^{w*}−Nₜ₋₁^{w*} (10)
wherein ΔNₜ^{w*} represents the change in full employment (measured in real wages) from time t−1 to time t; and Nₜ^{w*} and Nₜ₋₁^{w*} respectively represent full employment at time t and time t−1;
equation (10) shows that the change in full employment depends on short-term changes in full employment and real average wage; the change in full employment associated with the short-term change in labor force is not only closely related to the natural growth rate of a country's population, but also is closely related to the country's labor supply policy, involving a movement of a short-term labor supply curve;
ΔYₜ^{p}=Yₜ^{p}−Yₜ₋₁^{p} (11)
wherein ΔYₜ^{p} resents the change in potential output from time t−1 to time t; and Yₜ^{p} and Yₜ₋₁^{p} respectively represent potential output at time t and time t−1;
under the condition that the optimal wage-income ratio is set to be a constant, the change in potential output depends on the change in full employment; Yₜ^{p}=(1/gₜ^{*}) Nₜ^{w*} (8) is substituted into (11) to approximately obtain the following relationship:
ΔYₜ^{p}=(1/gₜ^{*})ΔNₜ^{w*} (12)
wherein ΔYₜ^{p} represents the change in potential output from time t−1 to time t; gₜ^{*}, represents the optimal wage-income ratio; ΔNₜ^{w*} represents the change in full employment;
and gₜ^{*} is assumed to be a constant.

8. The graphical method of claim 1, wherein a relationship between the supply-demand equilibrium curve and an income distribution is as follows:
at time t, the real gross wage Eₜ is equal to the employment Nₜ^{w} measured in the real wage-unit; and the real gross income Yₜ is equal to the real effective demand Y^{d}, that is, the equilibrium point Eₜⁿ(Nₜ^{w}, Yₜ^{d}) on the supply-demand equilibrium curve indicates not only the proportional relationship between the equilibrium employment Nₜ^{w} and the effective demand Yₜ^{d}, but also the proportional relationship between the real gross wage Eₜ and the real gross income Yₜ, i.e., the wage-income ratio:
gₜ=Eₜ/Yₜ (2)
changes in the slope of the supply-demand equilibrium curve and the income distribution;
from time t−n to time t, the change in wage-income ratio is expressed as (Nₜ^{w}−Nₜ₋ₙ^{w})/(Yₜ^{d}-Yₜ₋ₙ^{d}), and the slope of the supply-demand equilibrium curve is Sₜ^{N}=(Nₜ^{w}−Nₜ₋ₙ^{w}/(Yₜ^{d}−Yₜ₋ₙ^{d}) (4), so the slope of the supply-demand equilibrium curve in a certain period reflects the change trend of the wage-income ratio; by analyzing the change in the slope of the supply-demand equilibrium curve of the economy, the change in ratio of the gross wage to the gross income in the country is quantitatively investigated;
under the condition that the effective demand of an economy increases, the positive and negative signs of the slope of the supply-demand equilibrium curve reflect that the supply-demand equilibrium curve changes in three situations:
when Sₜⁿ>0, the supply-demand equilibrium curve tilts to the upper right, and the increase in effective demand at the time promotes the increase in employment; Sₜⁿ reflects the degree of change in wage-income ratio; if Sₜⁿ>gₜ₋ₙ (wage-income ratio at time t−n), the wage-income ratio increases; if Sₜⁿ=gₜ₋ₙ, the wage-income ratio is unchanged; if Sₜⁿ<gₜ₋ₙ, the wage-income ratio decreases;
when Sₜⁿ=0, the supply-demand equilibrium curve is vertical upwards, and the employment is unchanged as the effective demand increases, showing that the wage-income ratio is also unchanged; and
when Sₜⁿ<0, the supply-demand equilibrium curve tilts to the upper left; as the effective demand increases, the employment decreases, and the wage-income ratio decreases sharply; the absolute value of Sₜⁿ reflects the degree of decrease in the wage-income ratio.
The graphical method of claim 1, wherein a relationship between the supply-demand equilibrium curve and an income distribution is as follows:
at time t, the real gross wage Eₜ is equal to the employment Nₜ^{w} measured in the real wage-unit; and the real gross income Yₜ is equal to the real effective demand Y^{d}, that is, the equilibrium point Eₜⁿ(Nₜ^{w}, Yₜ^{d}) on the supply-demand equilibrium curve indicates not only the proportional relationship between the equilibrium employment Nₜ^{w} and the effective demand Yₜ^{d}, but also the proportional relationship between the real gross wage Eₜ and the real gross income Yₜ, i.e., the wage-income ratio:
gₜ=Eₜ/Yₜ (2)
changes in the slope of the supply-demand equilibrium curve and the income distribution;
from time t−n to time t, the change in wage-income ratio is expressed as (Nₜ^{w}−Nₜ₋ₙ^{w})/(Yₜ^{d}−Yₜ₋ₙ^{d}), and the slope of the supply-demand equilibrium curve is Sₜⁿ=(Nₜ^{w}−Nₜ₋ₙ^{w}/(Yₜ^{d}−Yₜ₋ₙ^{d}) (4), so the slope of the supply-demand equilibrium curve in a certain period reflects the change trend of the wage-income ratio; by analyzing the change in the slope of the supply-demand equilibrium curve of the economy, the change in ratio of the gross wage to the gross income in the country is quantitatively investigated;
under the condition that the effective demand of an economy increases, the positive and negative signs of the slope of the supply-demand equilibrium curve reflect that the supply-demand equilibrium curve changes in three situations:
when Sₜⁿ>0, the supply-demand equilibrium curve tilts to the upper right, and the increase in effective demand at the time promotes the increase in employment; Sₜⁿ reflects the degree of change in wage-income ratio; if Sₜⁿ>gₜ₋ₙ (wage-income ratio at time t−n), the wage-income ratio increases; if Sₜⁿ=gₜ₋ₙ, the wage-income ratio is unchanged; if Sₜⁿ<gₜ₋ₙ, the wage-income ratio decreases,
when Sₜⁿ=0, the supply-demand equilibrium curve is vertical upwards, and the employment is unchanged as the effective demand increases, showing that the wage-income ratio is also unchanged; and
when Sₜⁿ<0, the supply-demand equilibrium curve tilts to the upper left; as the effective demand increases, the employment decreases, and the wage-income ratio decreases sharply; the absolute value of Sₜⁿ reflects the degree of decrease in the wage-income ratio.

9. The graphical method of claim 3, wherein for the N^{w}-Y^{d} model of supply-demand equilibrium, the basic characteristics of the employment gap are described as follows:
when Nₜ^{wu}>0, Nₜ^{w}<Nₜ^{w*}; a certain distance exists between the supply-demand equilibrium curve and the fill employment curve, and a certain “involuntary” unemployment or the employment gap exists in the economy; the larger the employment gap is, the higher the social unemployment rate is;
when Nₜ^{wu}=0, Nₜ^{w}=Nₜ^{w*}; the supply-demand equilibrium curve and the full employment curve intersect at one point, and the economy does not have “involuntary” unemployment, and is in an ideal full employment state;
when Nₜ^{wu}<0, Nₜ^{w}>Nₜ^{w*}; the supply-demand equilibrium curve and the full employment curve have intersected before time t; at time t, the supply-demand equilibrium curve is at the upper right of the full employment curve, and the economy is in a special overemployment state;
under an assumption that ΔNₜ^{w*}≥0, three possibilities for the change in employment gap are caused due to the difference in the direction and magnitude of extension of the supply-demand equilibrium curve and the full employment curve:
when ΔNₜ^{wu}>0, ΔNₜ^{w}, ΔNₜ^{w*}; the increase in labor demand is smaller than the increase in labor supply, and the employment rate in a country declines;
when ΔNₜ^{wu}>0, ΔNₜ^{w}, ΔNₜ^{w*}, the change in labor demand is equal to the change in labor supply in the short term; and
when ΔNₜ^{wu}>0, ΔNₜ^{w}, ΔNₜ^{w*}, the increase in labor demand is greater than the increase in labor supply, and the employment rate in a country rises.

10. The graphical method of claim 1, wherein for the N^{w}-Y^{d} model of supply-demand equilibrium, the basic characteristics of the employment gap are described as follows:
when Nₜ^{wu}>0, Nₜ^{w}<Nₜ^{w*}; a certain distance exists between the supply-demand equilibrium curve and the full employment curve, and a certain “involuntary” unemployment or the employment gap exists in the economy; the larger the employment gap is, the higher the social unemployment rate is;
when Nₜ^{wu}=0, Nₜ^{w}=Nₜ^{w*}; the supply-demand equilibrium curve and the full employment curve intersect at one point, and the economy does not have “involuntary” unemployment, and is in an ideal full employment state;
when Nₜ^{wu}<0, Nₜ^{w}>Nₜ^{w*}; the supply-demand equilibrium curve and the full employment curve have intersected before time t; at time t, the supply-demand equilibrium curve is at the upper right of the full employment curve, and the economy is in a special overemployment state;
under an assumption that ΔNₜ^{w*}≥0, three possibilities for the change in employment gap are caused due to the difference in the direction and magnitude of extension of the supply-demand equilibrium curve and the full employment curve:
when ΔNₜ^{wu}>0, ΔNₜ^{w}<ΔNₜ^{w*}; the increase in labor demand is smaller than the increase in labor supply, and the employment rate in a country declines;
when ΔNₜ^{wu}=0, ΔNₜ^{w}=ΔNₜ^{w*}, the change in labor demand is equal to the change in labor supply in the short term; and
when ΔNₜ^{wu}<0, ΔNₜ^{w}>ΔNₜ^{w*}, the increase in labor demand is greater than the increase in labor supply, and the employment rate in a country rises.

11. The graphical method of claim 1, wherein the slope of the supply-demand equilibrium curve is larger than or equal to the slope of the full employment curve in the following three states;
in the first state, the supply-demand equilibrium curve coincides with the full employment curve, and the economy is in a stable equilibrium state for a long term; at the time, Sₜⁿ=Sₜ^{n*} and Nₜ^{w}=Nₜ^{w*} so the employment gap and the output gap are zero;
in the N^{w}-Y^{d} model, the basic characteristics of the full employment equilibrium are as follows; in the short term, the supply-demand equilibrium curve intersects with the full employment curve, that is, Nₜ^{w}=Nₜ^{w*}; in the long term, the slopes of the supply-demand equilibrium curve and the full employment curve are equal, and the two equilibrium curves coincide, that is, Sₜⁿ=Sₜ^{n*} and Nₜ^{w}=Nₜ^{w*}; from time t−n to time t, if the supply-demand equilibrium curve Nₜ^{y} fluctuates around the full employment curve Nₜ^{y*} within a given range, the economy achieves the full employment equilibrium in the period;
in the second state, in the presence of unemployment, if the slope of the supply-demand equilibrium curve is equal to the slope of the full employment curve, the employment rate is relatively stable for a long term;
in the N^{w}-Y^{d} model when Sₜⁿ=Sₜ^{n*} and Nₜ^{w}<Nₜ^{w*}, the employment gap and the output gap remain unchanged; if the real wage grows stably during the time period, the employment rate remains unchanged; and
in the third state, in the presence of unemployment, if the slope of the supply-demand equilibrium curve is greater than the slope of the full employment curve, the employment rate gradually rises.

12. A system for a graphical method for aggregate economic analysis, comprising:
an acquisition device configured to obtain annual and quarterly raw macroeconomic data of a country or region which comprises data of GDP, employment, price index, wage, and population, and comprising a server provided by a data service provider, a database connection tool, an external storage device or a manual input device; and
a processing device configured for long-term and short-term economic analyses, and comprising at least one central processing unit or specific processor.

13. The system of claim 12, wherein the processing device for the long-term economic analysis comprises:
a first data processing module, which is configured to establish macroeconomic time series of a N^{w}-Y^{d} model of annual supply-demand equilibrium based on the annual raw macroeconomic data acquired by the acquisition device;
a first constructing module for the N^{w}-Y^{d} model of supply-demand equilibrium, which is configured to construct the N^{w}-Y^{d} model of annual supply-demand equilibrium based on the macroeconomic time series of a N^{w}-Y^{d} model of annual supply-demand equilibrium;
an analyzing module for slopes of two curves, which is configured to respectively calculate a slope of a supply-demand equilibrium curve and a slope of a full employment curve at an overall period and different periods based on the N^{w}-Y^{d} model of annual supply-demand equilibrium, and to respectively compare the slopes of the supply-demand equilibrium curve at an overall period and different periods and the slope of a full employment curve;
an analysis module for a proportion of a wage income, which is configured to respectively calculate proportions of the wage income at the overall period and different period based on the N^{w}-Y^{d} model of annual supply-demand equilibrium, and to analyze long-term changes of the proportion of the wage income; and
an analysis module for a relationship of the supply-demand equilibrium curve and an income distribution, which is configured to analyze a relationship between the slope of the supply-demand equilibrium curve and the changes of the proportion of the wage income to analyze a long-term state of the economy.

14. The system of claim 13, wherein the processing device for the short-term economic analysis comprises:
a second data processing module, which is configured to establish macroeconomic time series of a N^{w}-Y^{d} model of quarterly supply-demand equilibrium in a country or region at a period based on the quarterly raw macroeconomic data acquired by the acquisition device;
a second constructing module for the N^{w}-Y^{d} model of supply-demand equilibrium, which is configured to construct the N^{w}-Y^{d} model of quarterly supply-demand equilibrium based on the macroeconomic time series of the N^{w}-Y^{d} model of quarterly supply-demand equilibrium;
an analysis module for an extension of the supply-demand equilibrium curve, which is configured to analyze a direction and amplitude of the extension of the supply-demand equilibrium curve in different stages based on the N^{w}-Y^{d} model of the quarterly supply-demand equilibrium; and
an analysis module for an employment gap and an output gap, which is configured to obtain time series of the employment gap and the output gap based on the N^{w}-Y^{d} model of annual or quarterly supply-demand equilibrium, and to explain a short-term state of the economy based on changes and relationship of the changed of the employment gap and the output gap.

15. The system of claim 14, further comprising a storage device configured to store the raw macroeconomic data, the N^{w}-Y^{d} model of supply-demand equilibrium and analyzed results of respective analysis modules.

16. The system of claim 15, further comprising an output device configured to output the N^{w}-Y^{d} model of supply-demand equilibrium and analyzed results of respective analysis modules.

17. The system of claim 16, further comprising a sending device configured to send the N^{w}-Y^{d} model of supply-demand equilibrium and analyzed results of respective analysis modules to a terminal.
